(19) United States
(12) Patent Application Publication
(10) Pub. No.: US 2025/0130399 A1
(43) Pub. Date: Apr. 24, 2025

(54) OPTICAL SYSTEM AND OPTICAL CAMERA

(71) Applicant: SHENZHEN METALENX TECHNOLOGY CO.,LTD, Shenzhen (CN)

(72) Inventors: Chunyu WANG, Shenzhen (CN); Heshan LIN, Shenzhen (CN); Chenglong HAO, Shenzhen (CN); Fengze TAN, Shenzhen (CN); Jian ZHU, Shenzhen (CN)

(73) Assignee: SHENZHEN METALENX TECHNOLOGY CO.,LTD, Shenzhen (CN)

(21) Appl. No.: 18/915,368

(22) Filed: Oct. 15, 2024

(30) Foreign Application Priority Data
Oct. 20, 2023 (CN) 202311366802.X
Oct. 20, 2023 (CN) 202322826179.3

(51) Int. Cl. G02B 13/00; G02B 1/00; G02B 1/02; G02B 9/12; G03B 17/12

(52) U.S. Cl. CPC G02B 13/0035; G02B 1/002; G02B 1/02; G02B 9/12; G02B 13/008; G03B 17/12

(57) ABSTRACT

An optical system and an optical camera are provided, and the optical system includes three optical elements. Along the optical axis in order from an object plane to an image plane, the three optical elements include: a first sulfur refractive lens, a metalens and a second sulfur refractive lens; each of three optical elements includes an object-side surface facing towards the object plane and an image-side surface facing towards the image plane; the first sulfur refractive lens and the second sulfur refractive lens are even aspheric optical lenses; the object-side surface of the first sulfur refractive lens is a convex surface; each of the object-side surface of the second sulfur refractive lens and the image-side surface of the second sulfur refractive lens includes one inflection point; the first sulfur refractive lens, the metalens and the second sulfur refractive lens have positive focal power.

### CROSS-REFERENCE TO RELATED APPLICATION

This application claims the benefit of priority from Chinese Patent Application No.202311366802.X and No.202322826179.3, filed on Oct. 20, 2023. The content of the aforementioned application, including any intervening amendments thereto, is incorporated herein by reference in its entirety.

### TECHNICAL FIELD

The present disclosure relates to a field of an optical lens, in particular to an optical system and an optical camera.

### BACKGROUND

Compared with the optical system working at a visible waveband, the optical system working at a far-infrared waveband is more suitable for the environment of rain, fog, snow and other working environments. In the relevant technology, for the optical system working at the far-infrared waveband, in order to enable the optical elements to provide the required phase of the optical system and realize the athermalization of the optical system, it is necessary to consider the distribution of positive and negative focal powers between different optical elements, which has the defect of low design freedom.

### SUMMARY

In order to solve the above technical problem, an optical system and an optical camera are provided according to the present application. In the present application, the phase provided by the optical elements can ensure good imaging quality of the optical system and realize the passive athermalization of the optical system without specifically considering the positive and negative distribution of focal power between different optical elements, and the design freedom of the optical system improves.

In the first aspect, an optical system is provided, the optical system including three optical elements, along the optical axis in order from an object plane to an image plane, the three optical elements include: a first sulfur refractive lens, a metalens and a second sulfur refractive lens;
each of three optical elements includes an object-side surface facing towards the object plane and an image-side surface facing towards the image plane;
the first sulfur refractive lens and the second sulfur refractive lens are even aspheric optical lenses;
the object-side surface of the first sulfur refractive lens is a convex surface;
each of the object-side surface of the second sulfur refractive lens and the image-side surface of the second sulfur refractive lens includes one inflection point;
the first sulfur refractive lens, the metalens and the second sulfur refractive lens have positive focal power.

In one embodiment, the optical system satisfies the following condition:

$$0.95 < f / epd < 1.05$$

f is an effective focal length of the optical system, and epd is a pupils diameter of the optical system.

In one embodiment, the optical system satisfies the following condition:

$$0.38 < BFL / f < 0.4$$

$$0.29 < BFL / TTL < 0.3$$

BFL is a back focal length of the optical system; f is an effective focal length of the optical system; TTL is a total track length of the optical system.

In one embodiment, the optical system satisfies the following condition:

$$- 1 \text{.5} < f * ( \frac{{R}_{1}}{{D}_{1}} - \frac{{R}_{5}}{{D}_{5}} ) / ( TTL - BFL ) < - 1$$

f is an effective focal length of the optical system, R₁ is a curvature radius of the object-side surface of the first sulfur refractive lens, D₁ is an effective radius of object-side surface of the first sulfur refractive lens, R₅ is a curvature radius of the object-side surface of the second sulfur refractive lens, D₅ is an effective radius of the object-side surface of the second sulfur refractive lens, TTL is a total track length of the optical system, BFL is a back focal length of the optical system.

In one embodiment, the optical system satisfies the following condition:

$$2.3 < f * ( n - 1 ) / ( FNO * {R}_{1} ) < 2.5$$

f is an effective focal length of the optical system; n is a refractive index of the first sulfur refractive lens, FNO is a F number of the optical system; R₁ is a curvature radius of the object-side surface of the first sulfur refractive lens.

In one embodiment, the optical system satisfies the following condition:

$$1.06 < {R}_{2} / {R}_{1} < 1.09$$

R₁ is a curvature radius of the object-side surface of the first sulfur refractive lens; R₂ is a curvature radius of the image-side surface of the first sulfur refractive lens.

In one embodiment, the optical system satisfies the following condition:

$$3.4 < {sag}_{21} / {sag}_{22} < 15.1$$

sag₂₁ is a sagittal height at a maximum radius of the object-side surface of the second sulfur refractive lens, sag₂₂ is a sagittal height at a maximum radius of the image-side surface of the second sulfur refractive lens.

In one embodiment, the optical system satisfies the following condition:

$$1.5 < {f}_{1} / f < 1.6$$

$$1.48 < {f}_{2} / f < 1.6$$

$$0.9 < {f}_{1} / {f}_{2} < 1.05$$

f₁ is a focal length of the first sulfur refractive lens, f₂ is a focal length of the second refractive lens, f is an effective focal length of the optical system.

In one embodiment, the optical system satisfies the following condition:

$$17 < {f}_{M} / f < 35.5$$

$$13 < 2 {f}_{M} / ( {f}_{1} + {f}_{2} ) < 29$$

f_{M} is a focal length of the metalens; f is an effective focal length of the optical system; f₁ is a focal length of the first sulfur refractive lens; f₂ is a focal length of the second sulfur refractive lens.

In one embodiment, the optical system satisfies the following condition:

$$1. 7 rad / mm < Δφ / {D}_{M} < 3.3 rad / mm$$

Δϕ is a maximum phase difference of the metalens, D_{M} is an effective optical radius of the metalens.

In one embodiment, the optical system satisfies the following condition:

$$0.1 < \vert {ca}_{1} / {ct}_{1} - c {a}_{2} / {ct}_{2} \vert < 0. 4$$

ca₁ is a paraxial distance between the central image-side surface of the first sulfur refractive lens and the metalens; ct₁ is a central thickness of the first sulfur refractive lens; ca₂ is a paraxial distance between the metalens and the central object-side surface of the second sulfur refractive lens; ct₂ is a central thickness of the second sulfur refractive lens.

In one embodiment, the optical system further includes: an aperture slot; the aperture slot is next to the object-side surface of the first sulfur refractive lens; the aperture slot is set on a surface of the metalens.

In one embodiment, the optical system further includes: an aperture slot; an air gap is set between the aperture slot and the metalens; the aperture slot is next to the object-side surface of the first sulfur refractive lens.

In a second aspect of the present application, an optical camera is provided, and the optical camera includes a lens barrel, and the optical system claimed as mentioned above;

the lens barrel includes three platforms, the three platforms are successively along the optical axis in order from an object plane to an image plane: a first platform, a second platform, and a third platform; the first sulfur refractive lens is set on the first platform, the metalens is set on the second platform, and the second sulfur refractive lens is set on the third platform.

In one embodiment, the optical camera includes: a first pressuring ring contacts the object-side surface of the first sulfur refractive lens; a disconnected ring contacts the image-side surface of the first sulfur refractive lens; and the disconnected ring contacts the object-side surface of the metalens; and a second pressuring ring contacts the image-side surface of the second sulfur refractive lens.

The optical system provided by the present application, and the optical system includes three optical elements. Along the optical axis in order from an object plane to an image plane, the three optical elements include: a first sulfur refractive lens, a metalens and a second sulfur refractive lens; each of three optical elements includes an object-side surface facing towards the object plane and an image-side surface facing towards the image plane; the first sulfur refractive lens and the second sulfur refractive lens are even aspheric optical lenses; the object-side surface of the first sulfur refractive lens is a convex surface; each of the object-side surface of the second sulfur refractive lens and the image-side surface of the second sulfur refractive lens includes one inflection point; the first sulfur refractive lens, the metalens and the second sulfur refractive lens have positive focal power. Because the metalens can provide phases that the optical system required neatly, and the first sulfur refractive lens and the second sulfur refractive lens will produce positive dispersion for the optical system, and the metalens will produce negative dispersion, there is no need to assign specific positive or negative focal powers to the first sulfur refractive lens, metalens and second sulfur refractive lens, the phase provided by each lens can ensure the good imaging quality of the optical system, and realize the athermalization of the optical system, so as to improve the design freedom of the optical system.

Other features and advantages of the present application will become apparent by the detailed description below, or will be acquired in part by the practice of the present application.

It should be understood that the above description is general, and the detailed description described below are exemplary only, and will not limit this application.

### BRIEF DESCRIPTION OF THE DRAWINGS

The above and other targets, features and advantages of the example embodiment thereof by reference to the accompanying drawings.

FIG. 1 shows a schematic diagram of the architectural layout of the optical system in one embodiment provided by the present application.

FIG. 2 shows a schematic diagram of the architectural layout of the optical camera in one embodiment provided by the present application.

FIG. 3 shows a schematic diagram of the architectural layout of the optical system in one embodiment provided by the present application.

FIG. 4 shows a curve diagram at room temperature between the MTF and field of view of the optical system in one embodiment provided by the present application.

FIG. 5 shows a curve diagram at the temperature of −40° C. between the MTF and field of view of the optical system in one embodiment provided by the present application.

FIG. 6 shows a curve diagram at the temperature of 80° C. between the MTF and field of view of the optical system in one embodiment provided by the present application.

FIG. 7 shows a field curvature diagram of the optical system in one embodiment provided by the present application.

FIG. 8 shows a distortion diagram of the optical system in one embodiment provided by the present application.

FIG. 9 shows a relative illumination diagram of the optical system in one embodiment provided by the present application.

FIG. 10 shows a chromatic aberration diagram of the vertical axis of the optical system in one embodiment provided by the present application.

FIG. 11 shows a spot diagram of imaging of the optical system at room temperature in one embodiment provided by the present application.

FIG. 12 shows a phase curve of the optical system in one embodiment provided by the present application.

FIG. 13 shows a schematic diagram of the architectural layout of the optical system in one embodiment provided by the present application.

FIG. 14 shows a curve diagram at room temperature between the MTF and field of view of the optical system in one embodiment provided by the present application.

FIG. 15 shows a curve diagram at the temperature of −40° C. between the MTF and field of view of the optical system in one embodiment provided by the present application.

FIG. 16 shows a curve diagram at the temperature of 80° C. between the MTF and field of view of the optical system in one embodiment provided by the present application.

FIG. 17 shows a field curvature diagram of the optical system in one embodiment provided by the present application.

FIG. 18 shows a distortion diagram of the optical system in one embodiment provided by the present application.

FIG. 19 shows a relative illumination diagram of the optical system in one embodiment provided by the present application.

FIG. 20 shows a chromatic aberration diagram of the vertical axis of the optical system in one embodiment provided by the present application.

FIG. 21 shows a spot diagram of imaging of the optical system at room temperature in one embodiment provided by the present application.

FIG. 22 shows a phase curve of the optical system in one embodiment provided by the present application.

FIG. 23 shows a schematic diagram of the architectural layout of the optical system in one embodiment provided by the present application.

FIG. 24 shows a curve diagram at room temperature between the MTF and field of view of the optical system in one embodiment provided by the present application.

FIG. 25 shows a curve diagram at the temperature of −40° C. between the MTF and field of view of the optical system in one embodiment provided by the present application.

FIG. 26 shows a curve diagram at the temperature of 80° C. between the MTF and field of view of the optical system in one embodiment provided by the present application.

FIG. 27 shows a field curvature diagram of the optical system in one embodiment provided by the present application.

FIG. 28 shows a distortion diagram of the optical system in one embodiment provided by the present application.

FIG. 29 shows a relative illumination diagram of the optical system in one embodiment provided by the present application.

FIG. 30 shows a chromatic aberration diagram of the vertical axis of the optical system in one embodiment provided by the present application.

FIG. 31 shows a spot diagram of imaging of the optical system at room temperature in one embodiment provided by the present application.

FIG. 32 shows a phase curve of the optical system in one embodiment provided by the present application.

FIG. 33 shows a schematic diagram of the architectural layout of the optical system in one embodiment provided by the present application.

FIG. 34 shows a curve diagram at room temperature between the MTF and field of view of the optical system in one embodiment provided by the present application.

FIG. 35 shows a curve diagram at the temperature of −40° C. between the MTF and field of view of the optical system in one embodiment provided by the present application.

FIG. 36 shows a curve diagram at the temperature of 80° C. between the MTF and field of view of the optical system in one embodiment provided by the present application.

FIG. 37 shows a field curvature diagram of the optical system in one embodiment provided by the present application.

FIG. 38 shows a distortion diagram of the optical system in one embodiment provided by the present application.

FIG. 39 shows a relative illumination diagram of the optical system in one embodiment provided by the present application.

FIG. 40 shows a chromatic aberration diagram of the vertical axis of the optical system in one embodiment provided by the present application.

FIG. 41 shows a spot diagram of imaging of the optical system at room temperature in one embodiment provided by the present application.

FIG. 42 shows a phase curve of the optical system in one embodiment provided by the present application.

FIG. 43 shows a schematic diagram of the architectural layout of the optical system in one embodiment provided by the present application.

FIG. 44 shows a curve diagram at room temperature between the MTF and field of view of the optical system in one embodiment provided by the present application.

FIG. 45 shows a curve diagram at the temperature of −40° C. between the MTF and field of view of the optical system in one embodiment provided by the present application.

FIG. 46 shows a curve diagram at the temperature of 80° C. between the MTF and field of view of the optical system in one embodiment provided by the present application.

FIG. 47 shows a field curvature diagram of the optical system in one embodiment provided by the present application.

FIG. 48 shows a distortion diagram of the optical system in one embodiment provided by the present application.

FIG. 49 shows a relative illumination diagram of the optical system in one embodiment provided by the present application.

FIG. 50 shows a chromatic aberration diagram of the vertical axis of the optical system in one embodiment provided by the present application.

FIG. 51 shows a spot diagram of imaging of the optical system at room temperature in one embodiment provided by the present application.

FIG. 52 shows a phase curve of the optical system in one embodiment provided by the present application.

### DETAILED DESCRIPTION OF DISCLOSURED EMBODIMENTS

The embodiments will be described more comprehensively with reference to the accompanying drawings. However, the embodiments can be implemented in various forms and should not be understood to be limited to the examples elaborated herein; instead, providing these embodiments makes the description of this application more comprehensive and complete and fully communicates the idea of the embodiment to those skilled in the art. The attached drawings are only schematic illustrations of this application and are not necessarily proportional drawings. The same reference marks in the figure indicate the same or similar parts, and their repeated descriptions will be omitted.

Furthermore, the described features, structures or features may be combined in one or more embodiments in any suitable manner. In the following description, many specific details are provided to give a full understanding of the exemplary embodiments of this application. However, those skilled in the art will be aware that one or more of the specific details may be omitted from the present technical solution, or other modules, components, etc. may be adopted. In other cases, aspects of the present application are blurred without detailed showing or describing the public structure, method, implementation or operation to avoid over dominance.

In the nature, there are few transparent materials at the far-infrared waveband that are more expensive than those transparent materials at the visible waveband or near-infrared waveband; even artificial sulfur glass materials are selected as the transparent materials at the far-infrared waveband, artificial sulfur glass materials are still more expensive. Therefore, the materials of the lens in the optical system working at the far-infrared waveband are greatly limited.

The refraction temperature coefficient of the transparent materials at the far-infrared usually will be 1-2 orders of magnitude higher than that of the transparent materials at the visible or infrared waveband. The refraction temperature coefficient is mainly used to describe the rate of change of the refractive index for the material with the temperature changing. When the refraction temperature coefficient is greater, at the same changes of the temperature, the refractive index of the material will be greater, thus leading to the greater instability of the corresponding optical system. It can be seen that compared with the optical system working at the visible waveband or near-infrared waveband, the optical system working at the far-infrared waveband is more difficult to realize the passive athermalization in prior art. And the present application provides an optical system that can realize the passive athermalization. As mentioned above, the optical system working at the far-infrared waveband, the material of the lens is greatly limited, so the optical system working at the far-infrared waveband further increases the difficulty of passive athermalization design.

In the prior art, the passive athermalization of optical system working at the far infrared waveband is mainly designed by the following method: assigning specific positive focal power for parts of the optical elements, and assigning specific negative focal power for parts of the optical elements. On the one hand, the phase provided by each lens can ensure that the optical system has a good imaging quality. On the other hand, in the processing of changing with the temperature, the influence caused by the refractive index changes of different optical elements will cancel each other out, thus realizing the passive athermalization.

It can be seen that in order to enable the optical elements to provide the phase required by the optical system and realize the athermalization of the optical system, the distribution of positive and negative focal powers between different optical elements needs to be specially considered, which has the defect of low design freedom.

In order to overcome the above defect, an optical system is provided by the present application can ensure the optical system have good imaging quality of the optical system by the phases provided by each lens and realize the passive athermalization of the optical system without assigning the positive or negative focal power of different optical elements of the optical system. And the design freedom of the optical system of present application improves.

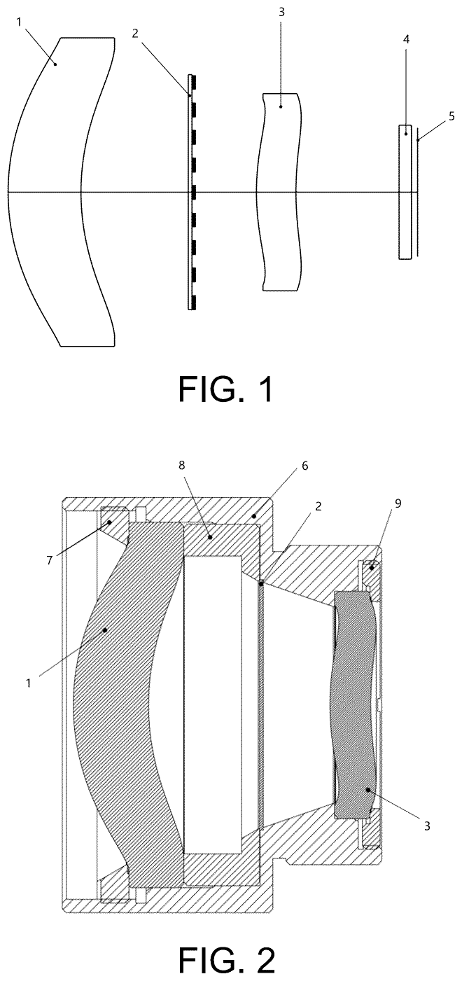

The optical system works at the far-infrared waveband. FIG. 1 shows a schematic diagram of the architectural layout of the optical system in one embodiment provided by the present application. The object plane is on the left of FIG. 1. Because the distance between the object plane and the optical system is uncertain, the object plane hasn't shown in FIG. 1. As shown in FIG. 1, the optical system including three optical elements, the three optical elements being, along the optical axis in order from an object plane to an image plane 5: a first sulfur refractive lens 1, a metalens 2 and a second sulfur refractive lens 3.

In the present embodiment, the metalens 2 includes a substrate and a plurality of unit cells, and the unit cells may be set on the surface of the substrate. The vertice or the center of the unit cell is set with nanostructures. The filler material filled between the nanostructures may be air or other transparent materials at the working waveband. The metalens 2 can provide the phases that the optical system required neatly through the modulation of the lights by the unit cells.

In the optical system provided by the present application, the first sulfur refractive lens and the second sulfur refractive lens are even aspheric optical lenses. And the object-side surface and the image-side surface of the first sulfur refractive lens are convex surfaces to the object plane of the optical system, that is, the first sulfur refractive lens is crescent to the object plane of the optical system. And each of the object-side surface of the second sulfur refractive lens and the image-side surface of the second sulfur refractive lens includes one inflection point.

It should be noted that the metalens 2 may provide the phases that the optical system required neatly, thus the metalens 2 may assign the focal powers between the three optical elements (the first sulfur refractive lens 1, metalens 2 and the second sulfur refractive lens 3). And the phases provided by the three optical elements can make sure good imaging quality of the optical system.

Moreover, the first sulfur refractive lens 1 and the second sulfur refractive lens 3 will produce positive dispersion for the optical system, and the metalens 2 will produce negative dispersion for the optical system. Thus, when the temperature changes, the thermal difference caused by the first sulfur refractive lens 1 and the second sulfur refractive lens 3 will be compensated by the metalens 2, so that the optical system realizes the passive athermalization.

Therefore, the present application can provide good imaging quality for the optical system without assigning specific positive or negative focal powers for the first sulfur refractive lens 1, metalens 2 and second sulfur refractive lens 3. The first sulfur refractive lens 1, metalens 2 and second sulfur refractive lens 3 have positive focal power, thus the phases provided by the metalens 2 will ensure the optical system have good imaging quality. And the optical system will realize the athermalization, and the design freedom of the optical system will improve.

Preferably, in one embodiment, the first sulfur refractive lens 1 and second sulfur refractive lens 2 are made of the same material. That is, the material of the first sulfur refractive lens 1 and second sulfur refractive lens 2 have the same refractive index and Abbe number. The cost of material of the optical system will significantly decrease by using the same material of the first sulfur refractive lens 1 and second sulfur refractive lens 2.

In one embodiment, the optical system satisfies the following condition:

$$0.95 < f / epd < 1.05 \qquad ( 1 )$$

f is an effective focal length of the optical system, and epd is an entrance pupil diameter of the optical system.

In the present application, the condition (1) describes the aperture number, namely F number of the optical system. F number of the optical system may also be recorded as FNO. With the decreasing of FNO, the light intake will increase, but the aberrations of the optical system will increase at the same time.

Thus, the lowest value of condition (1) is configured to be 0.95 to avoid FNO being too small, so that the optical system will ensure have good imaging quality. And the highest value of condition (1) is configured to be 1.05 to avoid FNO being too large and avoid the light intake of the optical system being too low, so that it prevents a significant decrease in energy utilization, thereby ensuring good imaging contrast.

In one embodiment, the optical system satisfies:

$$0.38 < BFL / f < 0.4 \qquad ( 2 )$$

$$0.29 < BFL / TTL < 0.3 \qquad ( 3 )$$

BFL is a back focal length of the optical system; f is an effective focal length of the optical system; TTL is a total track length of the optical system.

In the present embodiment, the back focal length and total track length of the optical system are limited within a reasonable limitation by setting two conditions (2) and (3).

Especially, the lowest value of condition (2) is configured to be 0.29 to avoid the back focal length of the optical system being too small. In this way, when the camera being assembled, the structural elements at the BFL region will avoid being interfered, so as to avoid the difficulty to install such structural elements (e.g. The difficulty of installing the shutter may be avoided by avoiding interference between the shutter and other structural elements). Moreover, the high value of condition (3) is configured to be 0.3 to avoid the BFL and the TTL being too large, so that the volume and the weight of the optical system avoid being too large.

In one embodiment, the optical system satisfies:

$$- 1 \text{.5} < f ⋆ ( \frac{{R}_{1}}{{D}_{1}} - \frac{{R}_{5}}{{D}_{5}} ) / ( TTL - BFL ) < - 1 \qquad ( 4 )$$

f is an effective focal length of the optical system, R₁ is a curvature radius of the object-side surface of the first sulfur refractive lens, D₁ is an effective radius of object-side surface of the first sulfur refractive lens, R₅ is a curvature radius of the object-side surface of the second sulfur refractive lens, D₅ is an effective radius of the object-side surface of the second sulfur refractive lens, TTL is a total track length of the optical system, BFL is a back focal length of the optical system.

In the present embodiment, the lowest value of condition (4) is configured to be −1.5, and the high value of condition (4) is configured to be −1, and the optical system has good imaging quality by two sulfur refractive optical elements and one metalens. Thus, the optical system avoids using too many optical elements and the optical system satisfies the requirements of good imaging quality, small volume and low cost.

In one embodiment, the optical system satisfies the following condition:

$$2.3 < f ⋆ ( n - 1 ) / ( FNO ⋆ {R}_{1} ) < 2.5 \qquad ( 5 )$$

f is an effective focal length of the optical system; n is a refractive index of the first sulfur refractive lens, FNO is a F number of the optical system; R₁ is a curvature radius of the object-side surface of the first sulfur refractive lens.

In the present embodiment, the lowest value of condition (5) is configured to be 2.3, and the highest value of condition (5) is configured to be 2.5, so that an imaging detector is set with a resolution of 640 pixels*512 pixels and an image size of 12 μm. Therefore, the optical system can meet the requirement of good imaging quality.

In one embodiment, the optical system satisfies the following condition:

$$1.06 < {R}_{2} / {R}_{1} < 1.09 \qquad ( 6 )$$

R₁ is a curvature radius of the object-side surface of the first sulfur refractive lens; R₂ is a curvature radius of the image-side surface of the first sulfur refractive lens.

Specifically, when the value of condition (6) is too small, which indicates that R₂ is smaller than R₁. R₂ is smaller, which indicates the curvature of the image-side of the second refractive lens is larger. In this way, the fabrication difficulty of the first sulfur refractive lens is getting greater.

When the value of condition (6) is too large, indicating R₂ is greater than R₁. R₁ is smaller, which indicates the curvature of the object-side surface of the first sulfur refractive lens is larger. Since the object-side surface and the image-side surface of the first sulfur refractive lens 1 are both convex to the object surface, when the curvature of the object-side surface is larger and the image-side surface is smaller, the paraxial distance between object-side surface of the first sulfur refractive lens and the image-side surface of the first sulfur refractive lens will be larger. That is, the thickness of the first sulfur refractive lens will be larger. Thus, the weight of the optical system will be larger.

Thus, the lowest value of condition (6) is configured to be 1.06, so as to avoid the curvature of the image-side surface of the first sulfur refractive lens being too large, which effectively reduces the fabrication difficulty of the first sulfur refractive lens 1. Moreover, the high value of condition (6) is configured to be 1.09, so as to avoid the thickness of the first sulfur refractive lens being too large, which effectively reduces the weight of the optical system.

The optical system satisfies the following condition:

$$3.4 < {sag}_{21} / {sag}_{22} < 15.1 \qquad ( 7 )$$

sag₂₁ is a sagittal height at a maximum radius of the object-side surface of the second sulfur refractive lens, sag₂₂ is a sagittal height at a maximum radius of the image-side surface of the second sulfur refractive lens.

It should be noted, for the object-side surface and image-side surface of the second sulfur refractive lens 3, the greater the sagittal height at maximum radius is, the greater the incident angle of the light at the edge of corresponding surface. As a result, the energy loss of the light at the edge of the corresponding surface increase, and the relative illumination at the edge of the imaging picture further reduces, which leads to the uneven brightness of the imaging picture.

Therefore, the lowest value of condition (7) is configured to be 3.4, and the highest value of condition (8) is configured to be 15.1, thus avoiding the sagittal height at maximum radius of object-side surface of the second sulfur refractive lens 3 and avoiding the sagittal height at maximum radius of image-side surface of the second sulfur refractive lens 3 being too large. In this way, the energy loss of the light at the edge of the corresponding surface will decrease and the degree of the relative illumination at the edge of image picture will decrease, so that the brightness uniformity of the imaging picture improves effectively.

The optical system satisfies the following condition:

$$1.5 < {f}_{1} / f < 1.6 \qquad ( 8 )$$

$$1.48 < {f}_{2} / f < 1.6 \qquad ( 9 )$$

$$0.9 < {f}_{1} / {f}_{2} < 1.05 \qquad ( 10 )$$

f₁ is a focal length of the first sulfur refractive lens, f₂ is a focal length of the second refractive lens, f is an effective focal length of the optical system.

In the present embodiment, the focal length of the first sulfur refractive lens, the focal length of the second sulfur refractive lens and the effective focal length of the optical system is limited by three conditions of (8), (9) and (10). Thus, the focal powers of the first sulfur refractive lens, the second sulfur refractive lens and the optical system are controlled with a reasonable range, so as to ensure that the optical system has good imaging quality.

Especially, the lowest value of condition (10) is configured to be 0.9, and the highest value of condition (10) is configured to be 1.05, which ensures that the relative symmetry of the first sulfur refractive lens 1 and the second sulfur refractive lens 3 in the optical system, and effectively reduces the off-axis aberration (mainly including coma and dispersion) of the optical system to improve the clarity at the edge of the image picture. In this way, the imaging quality of the optical system improves effectively.

In one embodiment, the optical system satisfies the following condition:

$$17 < {f}_{M} / f < 35.5 \qquad ( 11 )$$

$$13 < 2 {f}_{M} / ( {f}_{1} + {f}_{2} ) < 29 \qquad ( 12 )$$

f_{M} is a focal length of the metalens; f is an effective focal length of the optical system; f is an effective focal length of the optical system; f₁ is a focal length of the first sulfur refractive lens; f₂ is a focal length of the second sulfur refractive lens.

In the present embodiment, two conditions of (11) and (12) are mainly used to limit the focal power of the metalens 2 and the focal length or effective focal length of other combination of the optical elements in the optical system different from the metalens 2, thus controlling the focal power assigned for the metalens 2 and the focal power assigned for the other combination of the optical elements in the optical system within a reasonable range. In this way, the optical system satisfies the design requirements of the TTL and the imaging quality. In this embodiment, other combination of the optical elements in the optical system different from the metalens 2: the optical system; the first sulfur refractive lens 1 and the second sulfur refractive lens 3.

In particular, the lowest value is configured to be 13 and the highest value is configured to be 29, which can ensure the rationality of the distribution of optical element position to reduce the aberration of the optical system, thus the requirements of TTL and imaging quality of the optical system are satisfied at the same time.

In one embodiment, the optical system satisfies the following condition:

$$1.7 rad / mm < Δφ / {D}_{M} < 3.3 rad / mm \qquad ( 13 )$$

Δϕ is a maximum phase difference of the metalens, D_{M} is an effective radius of the metalens and the unit of the D_{M} is expressed in mm.

Specifically, condition (13) describes the maximum phase difference of the metalens 2 within its optical effective radius, which partly reflects the average phase gradient of the metalens 2. It should be noted that if the average phase gradient is too small, the correction capability of the chromatic aberration of metalens 2 will be too small, which leads to the difficulty of fully correction of the optical system. If the average phase gradient is too large, the nanostructures will require quite high phase provision capability. But at the same time, the phase provision capability of nanostructure is limited. Therefore, the selected nanostructure is difficult to match the target requirements, which will result in too large matching error.

Therefore, the lowest value of condition (13) is configured to be 1.7 rad/mm to avoid the average phase gradient being too small, and make sure that the metalens 2 is capable of fully correcting the chromatic aberration of the optical system. Moreover, the highest value of condition (13) is configured to be 3.3 rad/mm, thus avoiding the nanostructures will produce too large matching error.

In one embodiment, the optical system satisfies the following condition:

$$0.1 < \vert {ca}_{1} / {ct}_{1} - c {a}_{2} / {ct}_{2} \vert < 0.4 \qquad ( 14 )$$

ca₁ is a paraxial distance between the central image-side surface of the first sulfur refractive lens and the metalens; ct₁ is a central thickness of the first sulfur refractive lens; ca₂ is a paraxial distance between the metalens and the central object-side surface of the second sulfur refractive lens; ct₂ is a central thickness of the second sulfur refractive lens.

In one embodiment, the lowest value of condition (14) is configured to be 0.1, and the highest value of condition (14) is configured to be 0.4, thus ensuring relative symmetry of the first sulfur refractive lens 1, metalens 2 and the second sulfur refractive lens 3. In this way, the optical system avoids having too large axis-off aberrations (including coma and wavefront aberration), and the clarity at the edge of the imaging picture improves, thus effectively improving the imaging quality of the optical system.

In one embodiment, the optical system includes: an aperture slot, and the aperture slot is next to the object-side surface of the first sulfur refractive lens. The aperture slot is set on the object-side surface of the first sulfur refractive lens. Or an air gap is set between the aperture slot and the object-side surface of the first sulfur refractive lens 1.

In the present embodiment, the aperture slot is used to control the range of light intake. The aperture slot is set next to the object-side surface of the first sulfur refractive lens 1, which is beneficial to compress the lens (including the metalens and the second sulfur refractive lens) located behind the first sulfur refractive lens 1, thus further effectively reducing the aperture of the optical system.

In one embodiment, the optical system further includes: an optical window glass 4, and the optical window glass 4 is set between the second sulfur refractive lens 3 and the image plane 5. The optical window glass 4 is capable of protecting the optical system to improve the structural security. Moreover, the optical window glass 4 is also used to filter away the parasitic light.

In the present application, the optical camera is provided, and the optical camera includes: a lens barrel, and the optical system mentioned above.

The optical camera working at the far-infrared waveband provided by the embodiment. FIG. 2 shows a schematic diagram of the architectural layout of the optical camera in one embodiment provided by the present application.

As shown in FIG. 2, the lens barrel includes three platforms, the three platforms are successively along the optical axis in order from an object plane to an image plane: a first platform, a second platform, and a third platform; the first sulfur refractive lens is set on the first platform, the metalens is set on the second platform, and the second sulfur refractive lens is set on the third platform. Thus, through these three platforms, the various optical elements in the optical system are fixed to the inner wall of the lens barrel.

In one embodiment, a first pressuring ring contacts an object-side surface of the first sulfur refractive lens; a disconnected ring contacts an image-side surface of the first sulfur refractive lens; and the disconnected ring contacts the object-side surface of the metalens; and a second pressuring ring contacts the image-side surface of the second sulfur refractive lens.

It should be understood that each optical element may be fixed by the pressure ring and disconnected ring, and dispensing may be used to fix each optical element.

TABLE 1
Target requirements for the various system
parameters of the optical system

| System parameter | Data |
|---|---|
| F number | 1.0 ± 5% |
| Relative illumination | >95% |
| Distortion | <\|2%\| |
| MTF | >0.16 @0.8F 421p/mm |
| Working waveband | 8~12 μm |

Table 1 shows the target requirements for the various system parameters of the optical system. In detail, the optical system works at the far-infrared waveband, namely 8-12 μm. F number is greater than or equal to 0.95 and less than or equal to 1.05. The relative illumination is greater than 95%. The target requirement of the absolute value of distortion is less than 2%. For MTF at 0.8 FOV at a cut-off frequency of 42 lp/mm, the target requirement is greater than or equal to 0.16. And MTF (Modulation Transfer Function) is an important indicator used to describe the imaging quality of an optical system. The closer the value of MTF is to the diffraction limit, the better the imaging quality.

In the present embodiment, the optical system is designed to aim at the imaging detector with a resolution ratio of 640 pixels*512 pixels and pixel size of 12 μm, and the optical system with the imaging detector satisfies the requirement of good imaging quality. It should be noted, if the maximum image circle of the optical system matches the specifications of the imaging detector exactly, the maximum image circle is configured to be 9.84 mm. However, when the optical system and the image detector are assembled, there will be some assembly errors. In the present embodiment, the maximum image circle is configured to be 10.4 mm to leave a certain amount of space for the imaging, so as to avoid the assembly error resulting in a blank in some corner of the imaging picture during the final imaging.

With the target requirements shown in Table 1, the present application provides six embodiments with 5 optical systems that meet the target requirements shown in Table 1. Next, the six optical systems provided in this application are described in detail.

### Embodiment 1

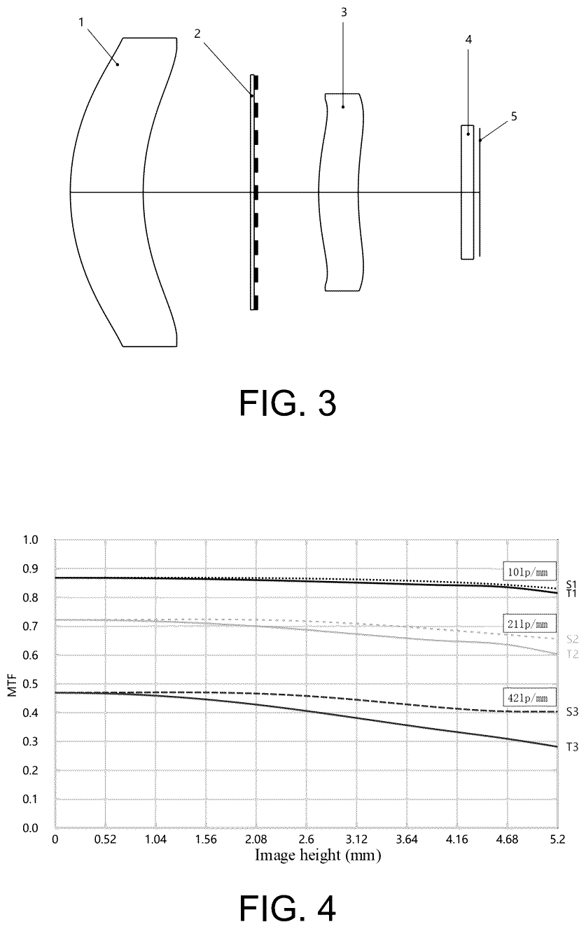

FIG. 3 shows a schematic diagram of the architectural layout of the optical system in embodiment 1 provided by the present application. As shown in FIG. 3, in embodiment 1, the optical system includes three optical elements. Along the optical axis in order from an object plane to an image plane, the three optical elements includes: an aperture slot, a first sulfur refractive lens, a metalens and a second sulfur refractive lens and an optical window glass. And the aperture slot is set on the object-side surface of the first sulfur refractive lens.

Along the direction from the object plane to the image plane, each surface of the optical system is numbered. After summarizing the parameters of each surface, Table 2 is obtained as shown below.

TABLE 2
parameters of each surface from the first
sulfur refractive lens to the image plane

| Surface | | Curvature | | |
|---|---|---|---|---|
| number | Type of surfaces | radius | Thickness | Material |
| 1 | Object plane | Infinite | — | — |
| 2 | Aspherical plane | 17.898 mm | 5.902 mm | Sulfur glass |
| | (Aperture slot ) | | | |
| 3 | Aspherical plane | 19.115 mm | 8.689 mm | — |
| 4 | Spherical surface | Infinite | 0.300 mm | Silicon |
| 5 | Spherical surface | Infinite | 5.221 mm | — |
| 6 | Aspherical surface | 20.497 mm | 3.200 mm | Sulfur glass |
| 7 | Aspherical surface | 26.504 mm | 8.349 mm | — |
| 8 | Spherical surface | Infinite | 1.000 mm | Germanium |
| 9 | Spherical surface | Infinite | 0.500 mm | — |
| 10 | Image plane | Infinite | — | — |

The surface 1 is an object plane. And surface 2 is an object-side surface of the first sulfur refractive lens. The surface 3 is an image-side surface of the first sulfur refractive lens. The surface 4 is an object-side surface of the metalens. The surface 5 is the image-side surface of the metalens. The surface 6 is the image-side surface of the second sulfur refractive lens. The surface 7 is the image-side surface of the second sulfur refractive lens. The surface 8 is the object-side surface of the optical window glass. The surface 9 is the image-side surface of the optical window glass. And the surface 10 is the image plane.

It can be seen from Table 2 that the curvature radius of surface 1 is infinite (namely, surface 1 is a plane), and the paraxial distance between the surface 1 and surface 2 is uncertain. And there is only air filled between the surface 1 and surface 2. The surface 2 is an aspherical surface with the curvature radius of 17.898 mm. And the aperture slot is co-planner with the surface 2. The paraxial distance between the surface 2 and the surface 3 is 5.902 mm, and the first sulfur refractive lens is made of sulfur glass. The surface 3 is an aspherical surface with the curvature radius of 19.115 mm, and the paraxial distance between the surface 3 and surface 4 is 8.689 mm, and air is filled between the surface 3 and surface 4. The surface 4 is a plane, and the paraxial distance between the surface 4 and surface 5 is 0.300 mm, and the metalens is made of silicon. The surface 5 is a plane, and the paraxial distance between the surface 6 and surface 5 is 5.221 mm, and air is filled between the surface 5 and surface 6. The surface 6 is an aspherical plane with the curvature radius of 20.497 mm. And the paraxial distance between the surface 6 and surface 7 is 3.200 mm, and the second sulfur refractive lens is made of sulfur glass. The surface 7 is an aspherical surface with the curvature radius of 26.504 mm. And the paraxial distance between the surface 7 and surface 8 is 8.349 mm, and air is filled between the surface 7 and surface 8. The surface 8 is a plane, and the paraxial distance between the surface 8 and surface 9 is 1.000 mm, and the optical window glass is made of Germanium. The surface 9 is a plane, and the distance between the surface 9 and surface 10 is 0.500 mm. And air is filled between the surface 9 and surface 10. The surface 10 is a plane.

For 4 aspherical surfaces of surface 2, surface 3, surface 6 and surface 7, these may be described by the following formula:

$$Z ( r ) = \frac{c {r}^{2}}{1 + \sqrt{1 - ( 1 + k ) {cr}^{2}}} + {A}_{2 i} {r}^{4 i} , i \geq 1$$

r represents the radius of any position in the direction of aperture of any optical lens, Z(r) represents the sagittal height of any position of optical lens, c represents the curvature of optical lens, k represent Cone coefficient of the optical lens, i is an integrity greater than or equal to 1, A₂ᵢ represents the 2i order coefficient.

After summarizing the coefficients in the surface formula corresponding to the four surfaces, Table 3 is shown below.

TABLE 3
Coefficients in the surface formula corresponding
to each aspherical surface in Embodiment 1

| | Numbered surface | | | |
|---|---|---|---|---|
| | 2 | 3 | 6 | 7 |
| k | −2.707E+00 | 1.255E−01 | 0 | 1.529E+00 |
| A₄ | 4.607E−05 | −2.546E−05 | −6.976E−05 | −8.268E−05 |
| A₆ | −2.914E−08 | −1.508E−08 | −2.030E−06 | −3.664E−06 |
| A₈ | −4.987E−010 | −4.802E−10 | −3.556E−08 | −1.021E−08 |
| A₁₀ | −6.412E−013 | −4.479E−11 | 6.714E−10 | 2.904E−10 |
| A₁₂ | 6.031E−016 | 3.090E−13 | −9.962E−12 | −8.744E−13 |
| A₁₄ | −5.547E−017 | −5.865E−16 | 0 | 0 |

The optical system provided in this embodiment works in the waveband from 8 to 12 μm; F number of the optical system is 1.01, and F number is within the range of the target requirement of 1.0±5%, which fully meets the requirements of the optical system for the F number.

FIG. 4 shows a curve diagram at room temperature between the MTF and field of view of the optical system in embodiment 1 provided by the present application. And room temperature usually refers to the temperature of 20° C. or 25° C. In FIG. 4, the horizontal axis represents the field of view with the image height with a unit of mm; the vertical axis represents the MTF value. In FIG. 4, T represents the meridional direction curve and S represents the sagittal direction curve; the meridional curve T1 and sagittal curve S1 correspond to the cut-off frequency of 10 lp/mm; the meridional curve T2 and sagittal curve S2 correspond to the cut-off frequency of 21 lp/mm; the meridional curve T3 and sagittal curve S3 correspond to the cut-off frequency of 42 lp/mm. And in FIG. 4, the image height of 5.2 mm corresponds to the range of all FOV, the image height of 4.16 mm corresponds to the range of 0.8 FOV.

From FIG. 4 can be seen, the MTF at 0.8 FOV of the optical systems at the cut-off frequency of 42.00 lp/mm is greater than 0.32 all the time. This shows that the imaging quality of the optical system in 0.8 FOV is excellent at room temperature.

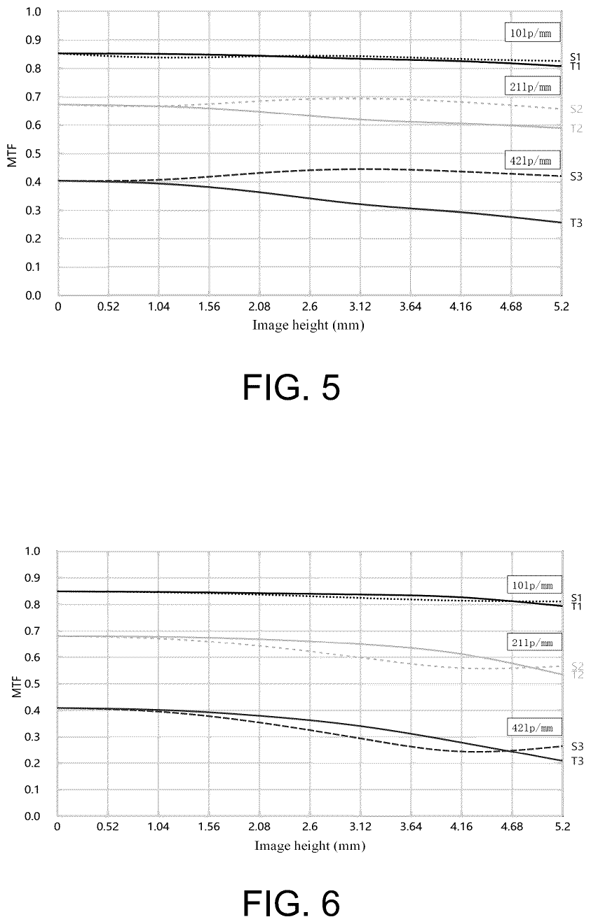

FIG. 5 shows a curve diagram at the temperature of −40° C. between the MTF and field of view of the optical system in embodiment 1 provided by the present application. Similarly, for the description of the meaning of the horizontal and vertical axis and the meaning of each curve, the meaning of the horizontal and vertical axis of FIG. 5 and the curve will not be repeated here.

As shown in FIG. 5, the MTF at 0.8 FOV at the cut-off frequency of 42.00 lp/mm is greater than 0.29, that is, the MTF of the optical system is greater than the target requirement of 0.16, which indicates the optical system at room temperature of 0.8 FOV has good imaging quality.

From FIG. 6 can be seen, the optical system provided by the present application, the MTF at a cut-off frequency of 42.00 lp/mm is greater than 0.24 at the temperature of 80° C. at 0.8 FOV, namely the MTF is greater than the target requirement of 016 all the time, which indicates that imaging quality of the optical system at the temperature of 80° C. is good.

From FIG. 4 to FIG. 6, the optical system provided by the present application at the temperature from −40° C. to 80° C. keeps good imaging quality all the time, which indicates that the optical system has fully realized the athermalization.

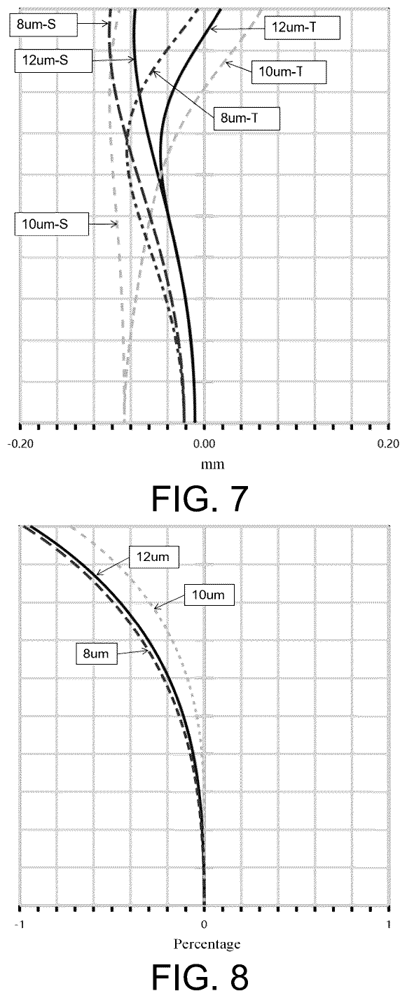

FIG. 7 shows a field curvature diagram of the optical system in Embodiment 1 provided by the present application. In FIG. 7, the horizontal axis represents the offset distance between the actual focus and the image plane with a unit of mm; the vertical axis represents the normalization FOV in the positive direction along the Y axis. FIG. 7 shows the field curve T in the meridional direction of the three wavelengths of 8 μm, 10 μm and 12 μm and the field curve S in the sagittal direction.

It can be seen from FIG. 7 that the field curvature in the meridional direction is 0.1494 mm at the central wavelength of 10 μm from 8 μm to 12 μm, and the field curvature in the sagittal direction is 0.0161 mm at the central wavelength of 10 μm from 8 μm to 12 μm, which indicates that the field curvature of the optical system is small.

FIG. 8 shows a distortion diagram of the optical system in Embodiment 1 provided by the present application. In FIG. 8, the horizontal axis represents the degree of the distortion of imaging and the unit of degree of the distortion is percentage; the vertical axis represents the normalization FOV in the positive direction along the Y axis. FIG. 8 shows the distortion curve at wavelength of 8 μm, the distortion curve at wavelength of 10 μm and the distortion curve at wavelength of 12 μm, respectively.

It can be seen from FIG. 8 that in the present application the distortions corresponding to each wavelength from 8 μm to 12 μm is less than 1.0%, that is, less than the target requirement of 2%, which indicates that the distortion of the optical system satisfying the target requirement of distortion.

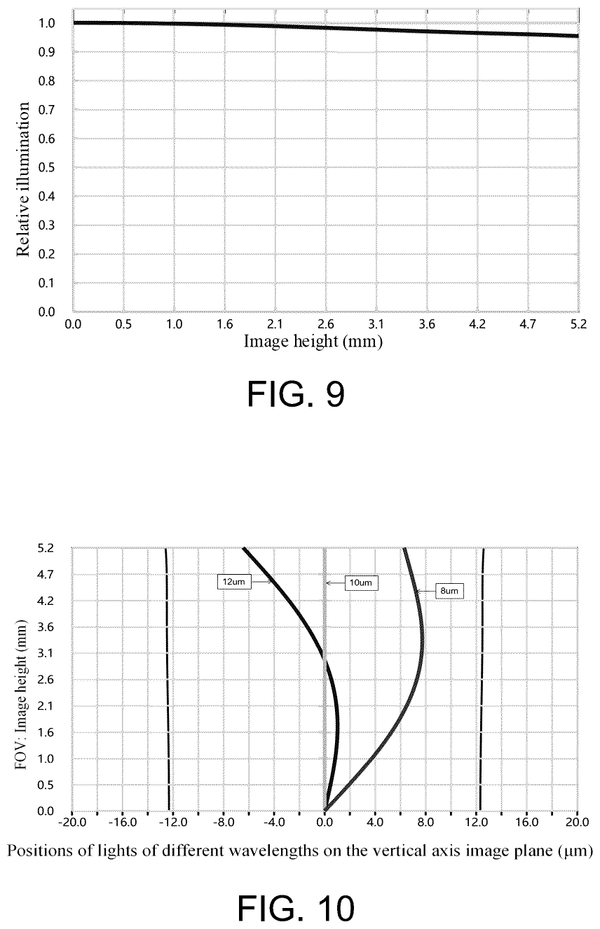

FIG. 9 shows a relative illumination diagram of the optical system in one embodiment provided by the present application. In FIG. 9, the horizontal axis represents the field of view with the image height with a unit of mm; the vertical axis represents the relative illumination. FIG. 9 shows a relative illumination curve at the central wavelength of 10 μm within the working waveband.

As shown in FIG. 9, at the central wavelength of 10 μm, the relative illumination at all fields of view of the optical system is greater than the target requirement of 95%, which will fully satisfy the target requirement of relative illumination.

FIG. 10 shows a chromatic aberration diagram of the vertical axis of the optical system in Embodiment 1 provided by the present application. In FIG. 10, the horizontal axis represents the offset between the position of the light at the vertical axis of the other wavelengths except the central wavelength of the working waveband and the position of the light at the vertical axis of the central wavelength of the working waveband, and the unit of the offset is expressed in μm; the vertical axis represents the FOV of the image height, and the unit expressed in mm. In FIG. 10, the curves on the outermost sides depict the diameter range of the Airy disk; except for the curves on the outermost sides, the remaining three curves are: the chromatic aberration curve of the wavelength of 8 μm, the chromatic aberration curve of the wavelength of 10 μm and the chromatic aberration curve of the wavelength of 12 μm.

In FIG. 10, at each wavelength of the waveband of 8-12 μm, the maximum chromatic aberration of vertical axis is about 12.2 μm, which is close to a size of pixel. The maximum chromatic aberrations of vertical axis are all located at the diameter range of the Airy disk, and the optical system still has a lot of margins, indicating the chromatic aberration of the optical system has been compensated well.

FIG. 11 shows a spot diagram of imaging of an optical system provided by Embodiment 1 at room temperature. In FIG. 11, the maximum root mean square radius at the all fields of view is 8.72 μm, which is less than the Airy disk radius of 12.32 μm, thus indicating that the optical system fully meets the requirements for clear imaging.

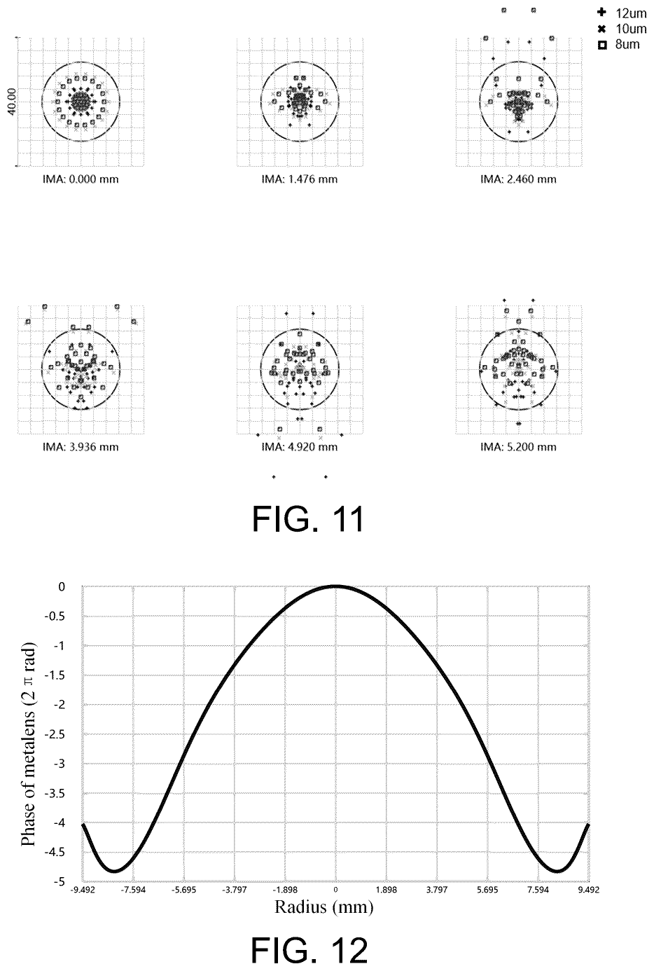

FIG. 12 shows a phase curve of the optical system provided by Embodiment 1. The horizontal axis of FIG. 12 represents the radius of the aperture of metalens, and the unit of the radius is expressed in mm; and the vertical axis represents the phase of the metalens corresponding to the position provided by the metalens, and the unit of the phase is expressed in 2 π/rad.

From FIG. 12 can be seen, the maximum phase difference of the metalens is less than 4.9*2 πrad.

### Embodiment 2

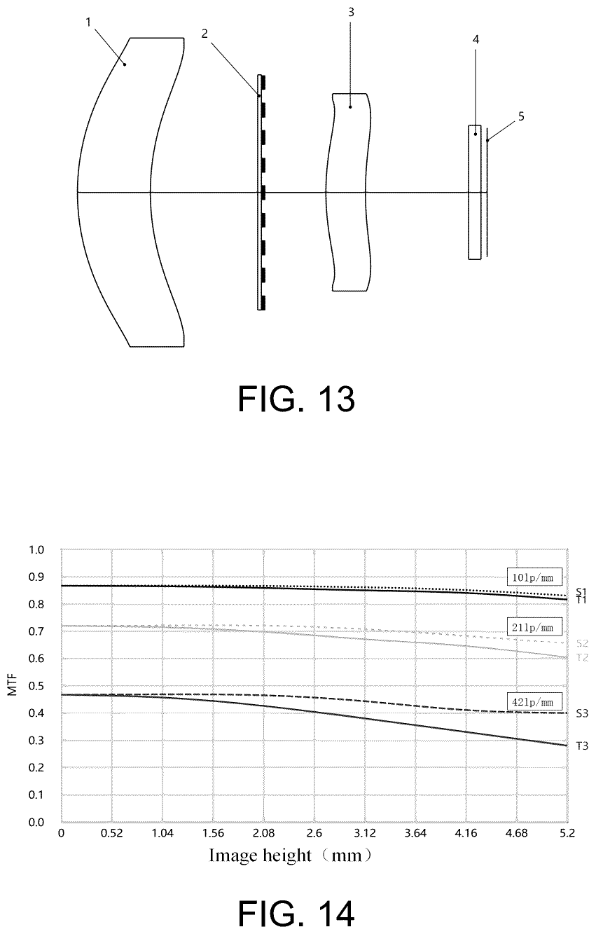

FIG. 13 shows a schematic diagram of the architectural layout of the optical system in embodiment 2 provided by the present application. As shown in FIG. 13, in embodiment 2, the optical system includes three optical elements. Along the optical axis in order from an object plane to an image plane, the three optical elements includes: an aperture slot, a first sulfur refractive lens, a metalens and a second sulfur refractive lens and an optical window glass. And the aperture slot is set on the object-side surface of the first sulfur refractive lens.

Along the direction from the object plane to the image plane, each surface of the optical system is numbered. After summarizing the parameters of each surface, Table 4 is obtained as shown below.

TABLE 4
parameters of each surface from the first sulfur
refractive lens to the image plane

| Surface | | Curvature | | |
|---|---|---|---|---|
| number | Type of surfaces | radius | Thickness | Material |
| 1 | Object plane | Infinite | — | — |
| 2 | Aspherical plane | 17.782 mm | 5.901 mm | Sulfur glass |
| | (Aperture slot) | | | |
| 3 | Aspherical plane | 18.890 mm | 8.778 mm | — |
| 4 | Spherical surface | Infinite | 0.300 mm | Silicon |
| 5 | Spherical surface | Infinite | 5.101 mm | |
| 6 | Aspherical surface | 21.202 mm | 3.200 mm | Sulfur glass |
| 7 | Aspherical surface | 27.758 mm | 8.348 mm | — |
| 8 | Spherical surface | Infinite | 1.000 mm | Germanium |
| 9 | Spherical surface | Infinite | 0.500 mm | — |
| 10 | Image plane | Infinite | — | — |

In the same way as described for Table 2, Table 4 is not repeated here.

After summarizing the coefficients in the surface formula corresponding to the four surfaces of surface 2, surface 3, surface 6 and surface 7, Table 5 is shown below.

TABLE 5
Coefficients in the surface formula corresponding
to each aspherical surface in Embodiment 2

| | Numbered surface | | | |
|---|---|---|---|---|
| | 2 | 3 | 6 | 7 |
| k | −2.829E+00 | 7.362E−04 | 0 | 2.769E+000 |
| A₄ | 5.063E−05 | −2.057E−05 | −6.791E−005 | −8.760E−005 |
| A₆ | −3.964E−08 | −3.593E−08 | −2.1101E−006 | −3.723E−006 |
| A₈ | −5.501E−10 | −1.087E−10 | −3.412E−008 | −6.778E−009 |
| A₁₀ | 8.259E−13 | −4.438E−11 | 6.665E−010 | 2.358E−010 |
| A₁₂ | −5.929E−15 | 2.815E−13 | −1.011E−011 | −6.147E−013 |
| A₁₄ | −4.623E−17 | −4.836E−16 | 0 | 0 |

The optical system provided in this embodiment works in the waveband from 8 to 12 μm; F number of the optical system is 1.01, and F number is within the range of the target requirement of 1.0±5%, which fully meets the requirements of the optical system for the F number.

In FIG. 14, the horizontal axis represents the field of view with the image height with a unit of mm; the vertical axis represents the MTF value. In the same way as the description of the meaning of the horizontal and vertical axis in FIG. 4 and the meaning of the curve, the meaning of the horizontal and vertical axis and the meaning of the curve in FIG. 14 will not be repeated here.

From FIG. 14 can be seen, the MTF at 0.8 FOV of the optical systems at the cut-off frequency of 42.00 lp/mm is greater than 0.32 all the time. That is, the MTF at 0.8 FOV of the optical systems at the cut-off frequency of 42.00 lp/mm is greater than the target requirement of 0.16. This shows that the imaging quality of the optical system in 0.8 FOV is excellent at room temperature.

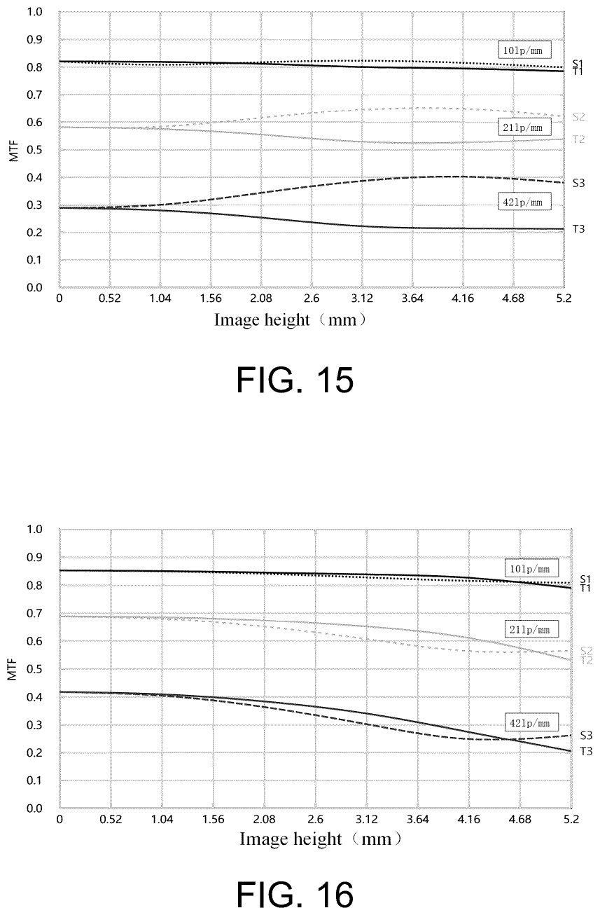

FIG. 15 shows a curve diagram at the temperature of −40° C. between the MTF and field of view of the optical system in Embodiment 2 provided by the present application. Similarly, for the description of the meaning of the horizontal and vertical axis and the meaning of each curve, the meaning of the horizontal and vertical axis of FIG. 15 and the curve will not be repeated here.

As shown in FIG. 15, the MTF of the optical system at 0.8 FOV of the cut-off frequency of 42.00 lp/mm is greater than 0.21, that is, the MTF of the optical system is greater than the target requirement of 0.16, which indicates the optical system at the temperature of −40° C. of 0.8 FOV has good imaging quality.

FIG. 16 shows a curve between the MTF of the optical system at a temperature of 80° C. in Embodiment 2 and the FOV. Similarly, for the meaning of the horizontal and vertical axis of FIG. 4 and the meaning of each curve, the meaning of the horizontal and vertical axis of FIG. 16 and each curve will not be repeated here.

From FIG. 16 can be seen, the optical system provided by the present application, the MTF at a cut-off frequency of 42.00 lp/mm is greater than 0.24 at the temperature of 80° C. at 0.8 FOV, namely the MTF is greater than the target requirement of 0.16 all the time, which indicates that imaging quality of the optical system at the temperature of 80° C. is good.

From FIG. 14 to FIG. 16, the optical system provided by the present application at the temperature from −40° C. to 80° C. keeps good imaging quality all the time, which indicates that the optical system has fully realized the athermalization.

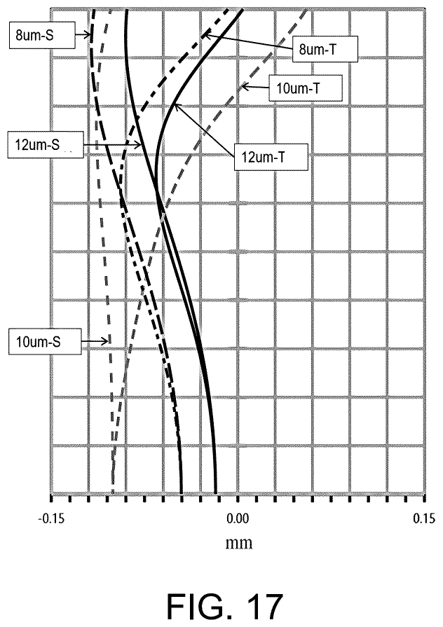

FIG. 17 shows a field curvature diagram of the optical system in Embodiment 2 provided by the present application. In the same way, for the meaning of the horizontal and vertical axis of FIG. 7 and the meaning of each curve, the meaning of the horizontal and vertical axis of FIG. 17 and the meaning of each curve will not be repeated here.

It can be seen from FIG. 17 that the field curvature in the meridional direction is 0.1557 mm at the central wavelength of 10 μm from 8 μm to 12 μm, and the field curvature in the sagittal direction is 0.0133 mm at the central wavelength of 10 μm from 8 μm to 12 μm, which indicates that the field curvature of the optical system is small.

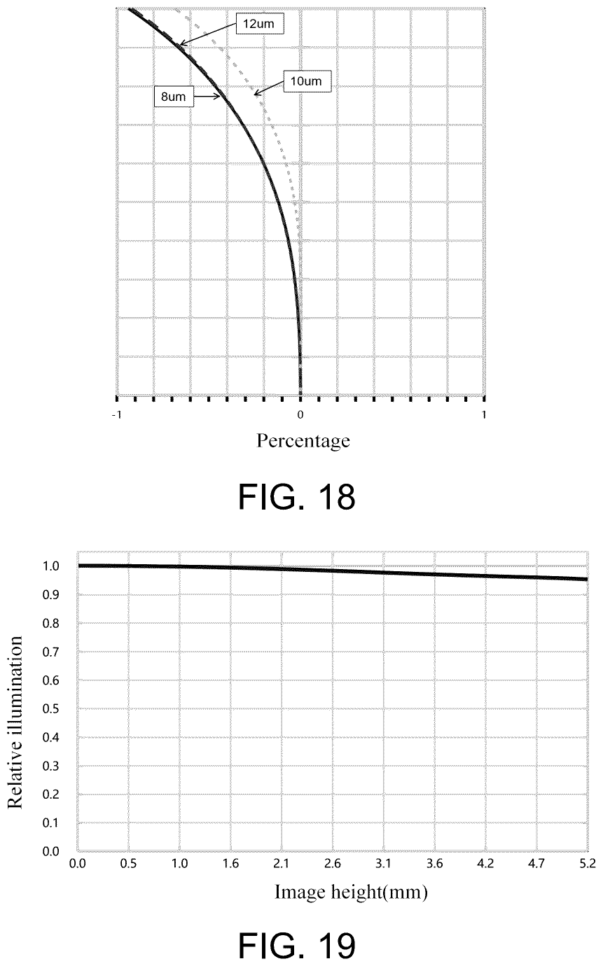

FIG. 18 shows a distortion diagram of the optical system in Embodiment 2 provided by the present application. In the same way, for the meaning of the horizontal and vertical axis of FIG. 8 and the meaning of each curve, the meaning of the horizontal and vertical axis of FIG. 18 and the meaning of each curve will not be repeated here.

It can be seen from FIG. 18 that in the present application the distortions corresponding to each wavelength from 8 μm to 12 μm is less than 1%, that is, less than the target requirement of 2%, which indicates that the distortion of the optical system satisfying the target requirement of distortion.

FIG. 19 shows a relative illumination diagram of the optical system in Embodiment 2 provided by the present application. In the same way, for the meaning of the horizontal and vertical axis of FIG. 9 and the meaning of each curve, the meaning of the horizontal and vertical axis of FIG. 19 and the meaning of each curve will not be repeated here.

As shown in FIG. 19, at the central wavelength of 10 μm, the relative illumination at all fields of view of the optical system is greater than the target requirement of 95%, which will fully satisfy the target requirement of relative illumination.

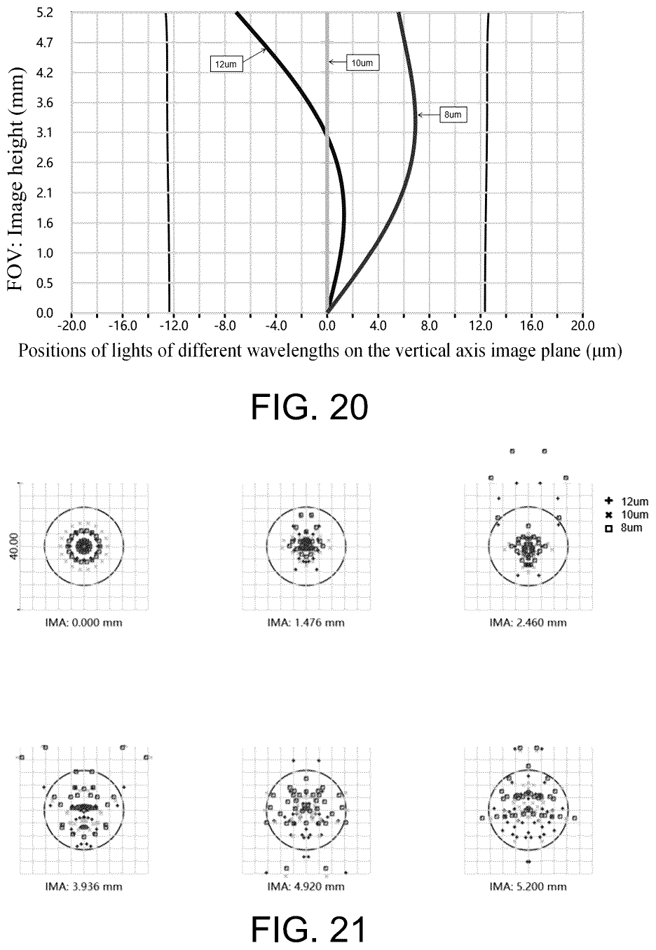

FIG. 20 shows a chromatic aberration diagram of the vertical axis of the optical system in Embodiment 2 provided by the present application. In the same way, for the meaning of the horizontal and vertical axis of FIG. 10 and the meaning of each curve, the meaning of the horizontal and vertical axis of FIG. 20 and the meaning of each curve will not be repeated here.

In FIG. 20, at each wavelength of the waveband of 8-12 μm, the maximum chromatic aberration of vertical axis is about 12.71 μm, which is close to a size of pixel. The maximum chromatic aberrations of vertical axis are all located at the diameter range of the Airy disk, and the optical system still has a lot of margins, indicating the chromatic aberration of the optical system has been compensated well.

FIG. 21 shows a spot diagram of imaging of an optical system provided by Embodiment 1 at room temperature. In FIG. 21, the maximum root mean square radius at the all fields of view is 9.753 μm, which is less than the Airy disk radius of 12.35 μm, thus indicating that the optical system fully meets the requirements for clear imaging.

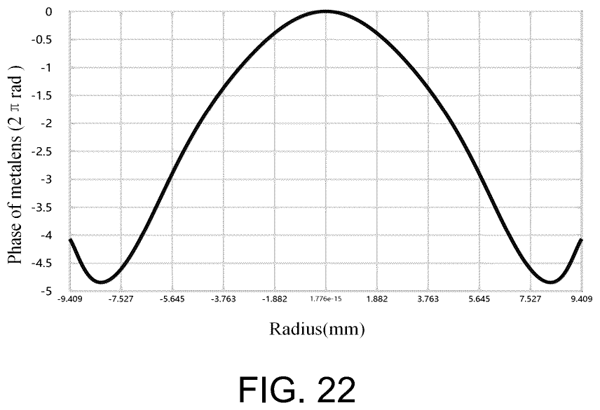

FIG. 22 shows a phase curve of the optical system provided by Embodiment 2. In the same way, for the meaning of the horizontal and vertical axis of FIG. 12 and the meaning of each curve, the meaning of the horizontal and vertical axis of FIG. 22 and the meaning of each curve will not be repeated here.

From FIG. 22 can be seen, the maximum phase difference of the metalens is less than 4.85*2 πrad.

### Embodiment 3

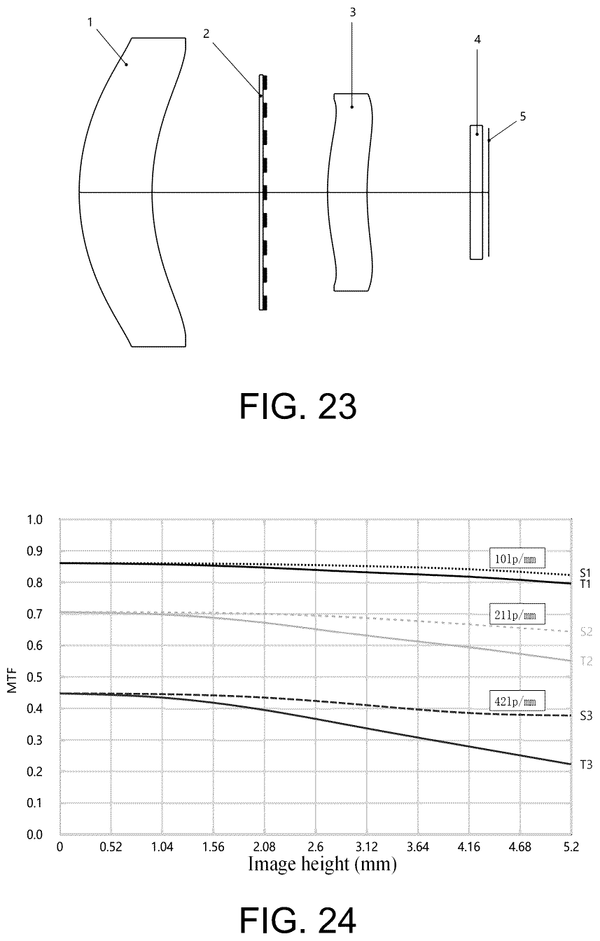

FIG. 23 shows a schematic diagram of the architectural layout of the optical system in embodiment 3 provided by the present application. As shown in FIG. 23, in embodiment 3, the optical system includes three optical elements. Along the optical axis in order from an object plane to an image plane, the three optical elements includes: an aperture slot, a first sulfur refractive lens, a metalens and a second sulfur refractive lens and an optical window glass. And the aperture slot is set on the object-side surface of the first sulfur refractive lens.

Along the direction from the object plane to the image plane, each surface of the optical system is numbered. After summarizing the parameters of each surface, Table 6 is obtained as shown below.

TABLE 6
parameters of each surface from the first
sulfur refractive lens to the image plane

| Surface | | Curvature | | |
|---|---|---|---|---|
| number | Type of surfaces | radius | Thickness | Material |
| 1 | Object plane | Infinite | — | — |
| 2 | Aspherical plane | 18.398 mm | 5.916 mm | Sulfur glass |
| | (Aperture slot) | | | |
| 3 | Aspherical plane | 19.841 mm | 10.276 mm | — |
| 4 | Spherical surface | Infinite | 0.300 mm | Silicon |
| 5 | Spherical surface | Infinite | 4.271 mm | — |
| 6 | Aspherical surface | 18.976 mm | 3.098 mm | Sulfur glass |
| 7 | Aspherical surface | 23.656 mm | 8.420 mm | — |
| 8 | Spherical surface | Infinite | 1.000 mm | Germanium |
| 9 | Spherical surface | Infinite | 0.500 mm | — |
| 10 | Image plane | Infinite | — | — |

In the same way as described for Table 2, Table 6 is not repeated here.

After summarizing the coefficients in the surface formula corresponding to the four surfaces of surface 2, surface 3, surface 6 and surface 7, Table 7 is shown below.

TABLE 7
Coefficients in the surface formula corresponding
to each aspherical surface in Embodiment 3

| | Numbered surface | | | |
|---|---|---|---|---|
| | 2 | 3 | 6 | 7 |
| k | −2.978E+00 | −8.791E−02 | 0 | −2.841E+00 |
| A₄ | 5.236E−05 | −8.441E−06 | −8.189E−05 | −6.853E−05 |
| A₆ | −1.054E−07 | −2.871E−07 | −2.605E−06 | −4.110E−06 |
| A₈ | −5.018E−10 | 1.986E−09 | −1.670E−08 | −1.726E−10 |
| A₁₀ | 4.641E−12 | −3.927E−11 | 3.133E−10 | 2.099E−10 |
| A₁₂ | −3.031E−14 | 1.889E−13 | −7.164E−12 | −6.369E−13 |
| A₁₄ | 1.523E−17 | −2.474E−16 | 0 | 0 |

The optical system provided in this embodiment works in the waveband from 8 to 12 μm; F number of the optical system is 1.02, and F number is within the range of the target requirement of 1.0±5%, which fully meets the requirements of the optical system for the F number.

FIG. 24 shows a curve diagram of the optical system at room temperature between the MTF and FOV. In the same way as the description of the meaning of the horizontal and vertical axis in FIG. 4 and the meaning of the curve, the meaning of the horizontal and vertical axis and the meaning of the curve in FIG. 24 will not be repeated here.

From FIG. 24 can be seen, the MTF at 0.8 FOV of the optical systems at the cut-off frequency of 42.00 lp/mm is greater than 0.27 all the time. That is, MTF at 0.8 FOV of the optical systems at the cut-off frequency of 42.00 lp/mm is greater than the target requirement of 0.16. This shows that the imaging quality of the optical system in 0.8 FOV is excellent at room temperature.

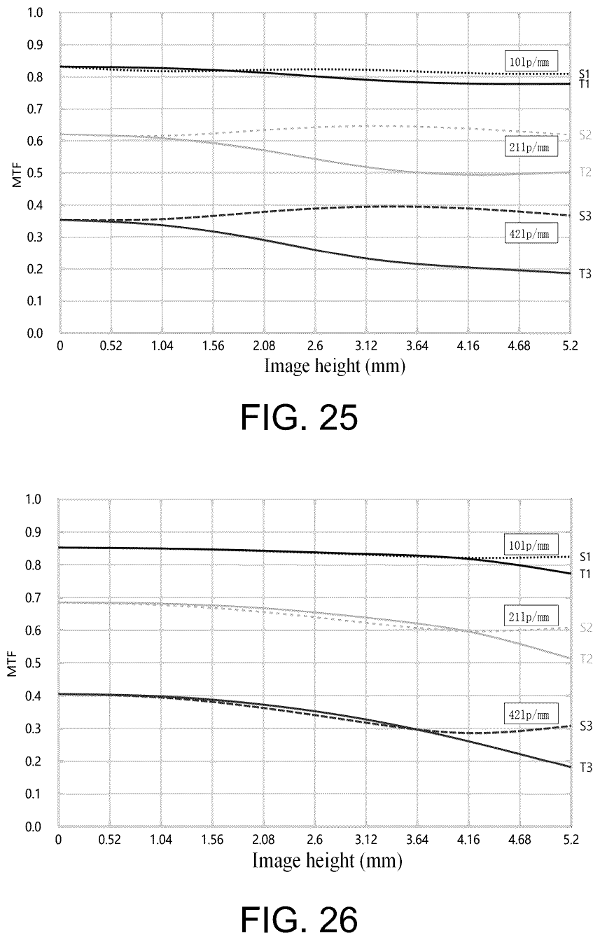

FIG. 25 shows a curve diagram at the temperature of −40° C. between the MTF and field of view of the optical system in Embodiment 3 provided by the present application. Similarly, for the description of the meaning of the horizontal and vertical axis and the meaning of each curve, the meaning of the horizontal and vertical axis of FIG. 25 and the curve will not be repeated here.

As shown in FIG. 25, the MTF of the optical system at 0.8 FOV of the cut-off frequency of 42.00 lp/mm is greater than 0.20, that is, the MTF of the optical system is greater than the target requirement of 0.16, which indicates the optical system at the temperature of −40° C. of 0.8 FOV has good imaging quality.

FIG. 26 shows a curve between the MTF of the optical system at a temperature of 80° C. in Embodiment 3 and the FOV. Similarly, for the meaning of the horizontal and vertical axis of FIG. 4 and the meaning of each curve, the meaning of the horizontal and vertical axis of FIG. 26 and each curve will not be repeated here.

From FIG. 26 can be seen, the optical system provided by the present application, the MTF at a cut-off frequency of 42.00 lp/mm is greater than 0.26 at the temperature of 80° C. at 0.8 FOV, namely the MTF is greater than the target requirement of 0.16 all the time, which indicates that imaging quality of the optical system at the temperature of 80° C. is good.

From FIG. 24 to FIG. 26, the optical system provided by the present application at the temperature from −40° C. to 80° C. keeps good imaging quality all the time, which indicates that the optical system has fully realized the athermalization.

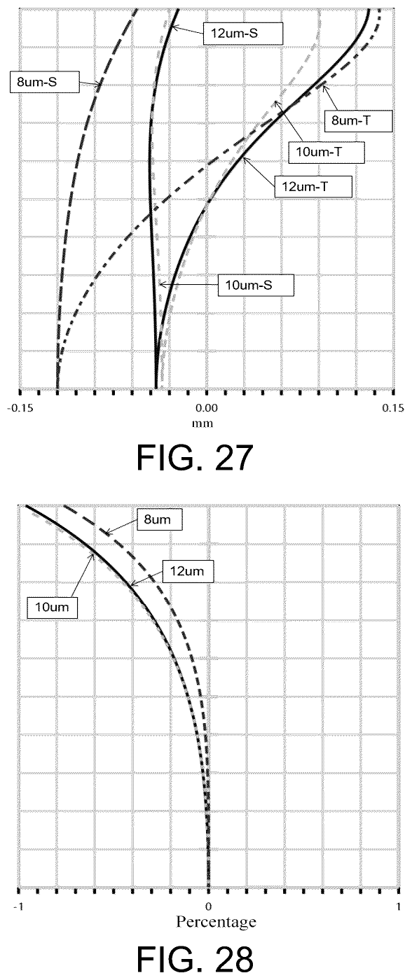

FIG. 27 shows a field curvature diagram of the optical system in Embodiment 3 provided by the present application. In the same way, for the meaning of the horizontal and vertical axis of FIG. 7 and the meaning of each curve, the meaning of the horizontal and vertical axis of FIG. 27 and the meaning of each curve will not be repeated here.

It can be seen from FIG. 27 that the field curvature in the meridional direction is 0.1269 mm at the central wavelength of 10 μm from 8 μm to 12 μm, and the field curvature in the sagittal direction is 0.0140 mm at the central wavelength of 10 μm in the waveband from 8 μm to 12 μm, which indicates that the field curvature of the optical system is small.

FIG. 28 shows a distortion diagram of the optical system in Embodiment 3 provided by the present application. In the same way, for the meaning of the horizontal and vertical axis of FIG. 8 and the meaning of each curve, the meaning of the horizontal and vertical axis of FIG. 28 and the meaning of each curve will not be repeated here.

It can be seen from FIG. 28 that in the present application the distortions corresponding to each wavelength from 8 μm to 12 μm is less than 1.0%, that is, less than the target requirement of 2%, which indicates that the distortion of the optical system satisfying the target requirement of distortion.

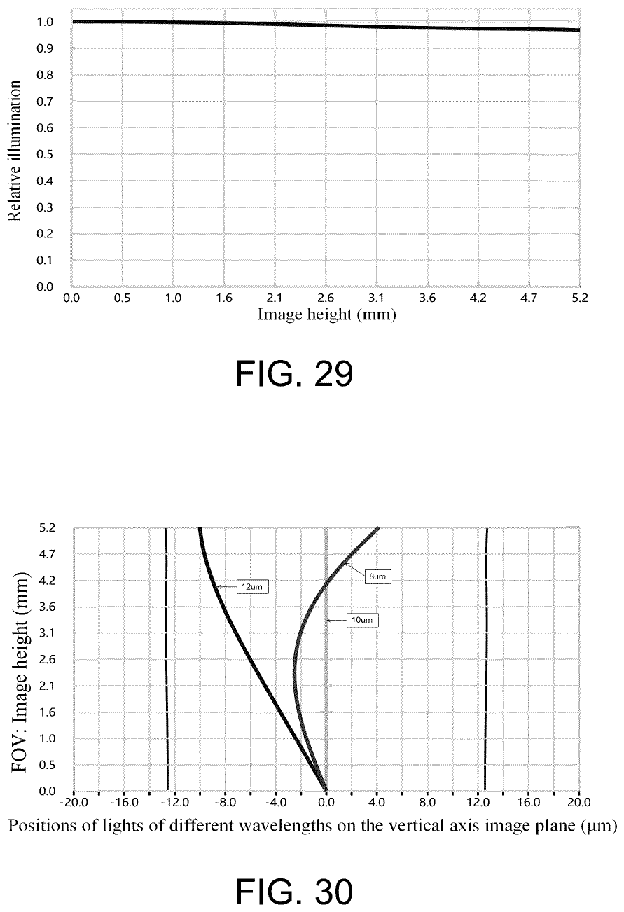

FIG. 29 shows a relative illumination diagram of the optical system in Embodiment 3 provided by the present application. In the same way, for the meaning of the horizontal and vertical axis of FIG. 9 and the meaning of each curve, the meaning of the horizontal and vertical axis of FIG. 29 and the meaning of each curve will not be repeated here.

As shown in FIG. 29, at the central wavelength of 10 μm, the relative illumination at all fields of view of the optical system is greater than 97% all the time, that is, is greater than the target requirement of 95%, which will fully satisfy the target requirement of relative illumination.

FIG. 30 shows a chromatic aberration diagram of the vertical axis of the optical system in Embodiment 3 provided by the present application. In the same way, for the meaning of the horizontal and vertical axis of FIG. 10 and the meaning of each curve, the meaning of the horizontal and vertical axis of FIG. 30 and the meaning of each curve will not be repeated here.

In FIG. 30, at each wavelength of the waveband of 8-12 μm, the maximum chromatic aberration of vertical axis is about 14.17 μm, which is close to a size of pixel. The maximum chromatic aberrations of vertical axis are all located at the diameter range of the Airy disk, and the optical system still has a lot of margins, indicating the chromatic aberration of the optical system has been compensated well.

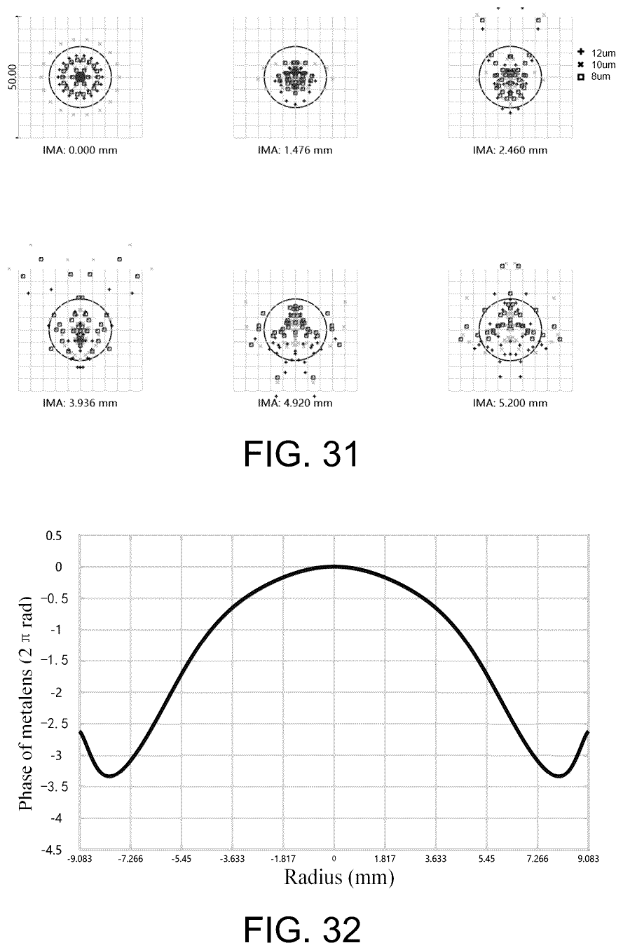

FIG. 31 shows a spot diagram of imaging of an optical system provided by Embodiment 3 at room temperature. In FIG. 31, the maximum root mean square radius at the all fields of view is 13.916 μm, which is close to the Airy disk radius of 12.56 μm, and the maximum root square radius at the 0.8 FOV, thus indicating that the optical system fully meets the requirements for clear imaging.

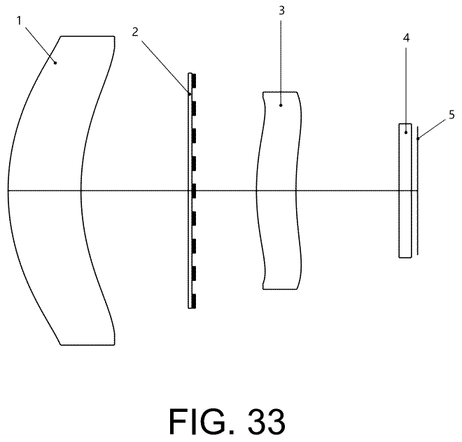

FIG. 32 shows a phase curve of the optical system provided by Embodiment 3. In the same way, for the meaning of the horizontal and vertical axis of FIG. 12 and the meaning of each curve, the meaning of the horizontal and vertical axis of FIG. 32 and the meaning of each curve will not be repeated here.

From FIG. 32 can be seen, the maximum phase difference of the metalens is less than 3.4*2 πrad.

### Embodiment 4

FIG. 33 shows a schematic diagram of the architectural layout of the optical system in embodiment 3 provided by the present application. As shown in FIG. 33, in embodiment 4, the optical system includes three optical elements. Along the optical axis in order from an object plane to an image plane, the three optical elements includes: an aperture slot, a first sulfur refractive lens, a metalens and a second sulfur refractive lens and an optical window glass. And the aperture slot is set on the object-side surface of the first sulfur refractive lens.

Along the direction from the object plane to the image plane, each surface of the optical system is numbered. After summarizing the parameters of each surface, Table 8 is obtained as shown below.

TABLE 8
parameters of each surface from the first
sulfur refractive lens to the image plane

| Surface | | Curvature | | |
|---|---|---|---|---|
| number | Type of surfaces | radius | Thickness | Material |
| 1 | Object plane | Infinite | — | — |
| 2 | Aspherical plane | 18.495 mm | 5.984 mm | Sulfur glass |
| | (Aperture slot) | | | |
| 3 | Aspherical plane | 20.002 mm | 10.215 mm | — |
| 4 | Spherical surface | Infinite | 0.300 mm | Silicon |
| 5 | Spherical surface | Infinite | 4.267 mm | — |
| 6 | Aspherical surface | 19.627 mm | 3.120 mm | Sulfur glass |
| 7 | Aspherical surface | 24.679 mm | 8.422 mm | |
| 8 | Spherical surface | Infinite | 1.000 mm | Germanium |
| 9 | Spherical surface | Infinite | 0.500 mm | — |
| 10 | Image plane | Infinite | — | — |

In the same way as described for Table 2, Table 8 is not repeated here.

After summarizing the coefficients in the surface formula corresponding to the four surfaces of surface 2, surface 3, surface 6 and surface 7, Table 9 is shown below.

TABLE 9
Coefficients in the surface formula corresponding
to each aspherical surface in Embodiment 4

| | Numbered surface | | | |
|---|---|---|---|---|
| | 2 | 3 | 6 | 7 |
| k | −3.001E+00 | −9.619E−02 | 0 | −2.688E+00 |
| A₄ | 5.187E−05 | −8.238E−06 | −8.197E−05 | −6.955E−05 |
| A₆ | −1.072E−07 | −2.948E−07 | −2.594E−06 | −4.254E−06 |
| A₈ | −4.814E−10 | 1.990E−09 | −1.864E−08 | 1.474E−09 |
| A₁₀ | 4.636E−12 | −3.902E−11 | 3.117E−10 | 2.532E−10 |
| A₁₂ | −3.189E−14 | 1.895E−13 | −6.762E−12 | −1.141E−12 |
| A₁₄ | 2.274E−17 | −2.495E−16 | 0 | 0 |

The optical system provided in this embodiment works in the waveband from 8 to 12 μm; F number of the optical system is 1.02, and F number is within the range of the target requirement of 1.0±5%, which fully meets the requirements of the optical system for the F number.

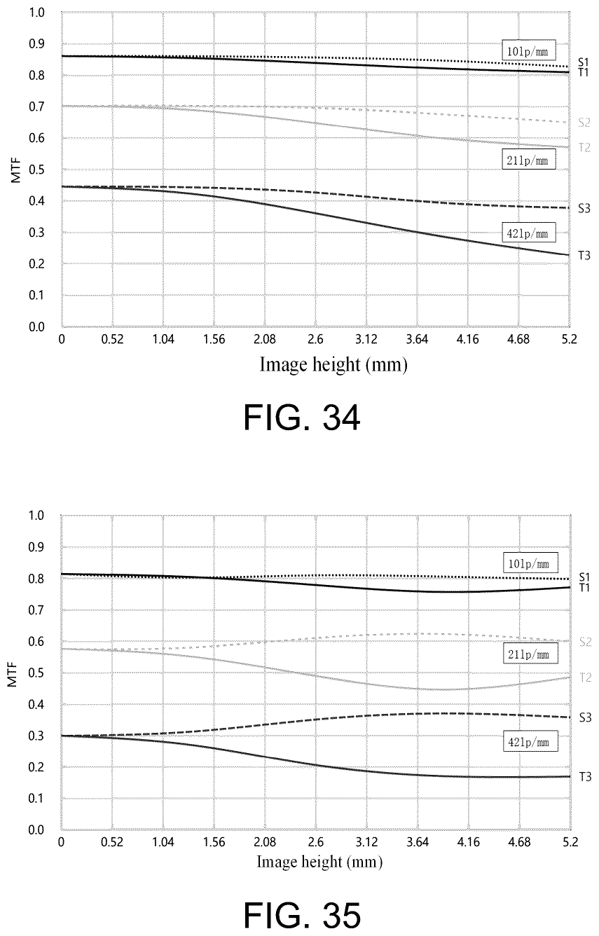

FIG. 34 shows a curve diagram of the optical system at room temperature between the MTF and FOV. In the same way as the description of the meaning of the horizontal and vertical axis in FIG. 4 and the meaning of the curve, the meaning of the horizontal and vertical axis and the meaning of the curve in FIG. 34 will not be repeated here.

From FIG. 34 can be seen, the MTF at 0.8 FOV of the optical systems at the cut-off frequency of 42.00 lp/mm is greater than 0.27 all the time. That is, the MTF is greater than the target requirement of 0.16 all the time. This shows that the imaging quality of the optical system in 0.8 FOV is excellent at room temperature.

FIG. 35 shows a curve diagram at the temperature of −40° C. between the MTF and field of view of the optical system in Embodiment 4 provided by the present application. Similarly, for the description of the meaning of the horizontal and vertical axis and the meaning of each curve, the meaning of the horizontal and vertical axis of FIG. 35 and the curve will not be repeated here.

As shown in FIG. 35, the MTF of the optical system at 0.8 FOV of the cut-off frequency of 42.00 lp/mm is greater than 0.17, that is, the MTF of the optical system is greater than the target requirement of 0.16, which indicates the optical system at a temperature of −40° C. of 0.8 FOV has good imaging quality.

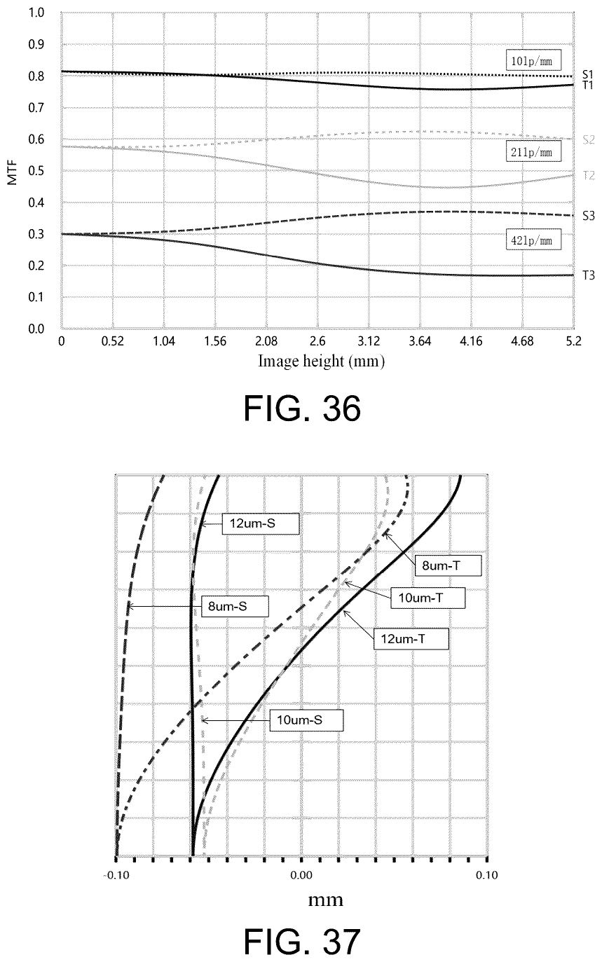

FIG. 36 shows a curve between the MTF of the optical system at a temperature of 80° C. in Embodiment 4 and the FOV. Similarly, for the meaning of the horizontal and vertical axis of FIG. 4 and the meaning of each curve, the meaning of the horizontal and vertical axis of FIG. 36 and each curve will not be repeated here.

From FIG. 36 can be seen, the optical system provided by the present application, the MTF at a cut-off frequency of 42.00 lp/mm is greater than 0.17 at the temperature of 80° C. at 0.8 FOV, namely the MTF is greater than the target requirement of 0.16 all the time, which indicates that imaging quality of the optical system at the temperature of 80° C. is good.

From FIG. 34 to FIG. 36, the optical system provided by the present application at the temperature from −40° C. to 80° C. keeps good imaging quality all the time, which indicates that the optical system has fully realized the athermalization.

FIG. 37 shows a field curvature diagram of the optical system in Embodiment 4 provided by the present application. In the same way, for the meaning of the horizontal and vertical axis of FIG. 7 and the meaning of each curve, the meaning of the horizontal and vertical axis of FIG. 37 and the meaning of each curve will not be repeated here.

It can be seen from FIG. 37 that the field curvature in the meridional direction is 0.0991 mm at the central wavelength of 10 μm from 8 μm to 12 μm, and the field curvature in the sagittal direction is 0.0065 mm at the central wavelength of 10 μm in the waveband from 8 μm to 12 μm, which indicates that the field curvature of the optical system is small.

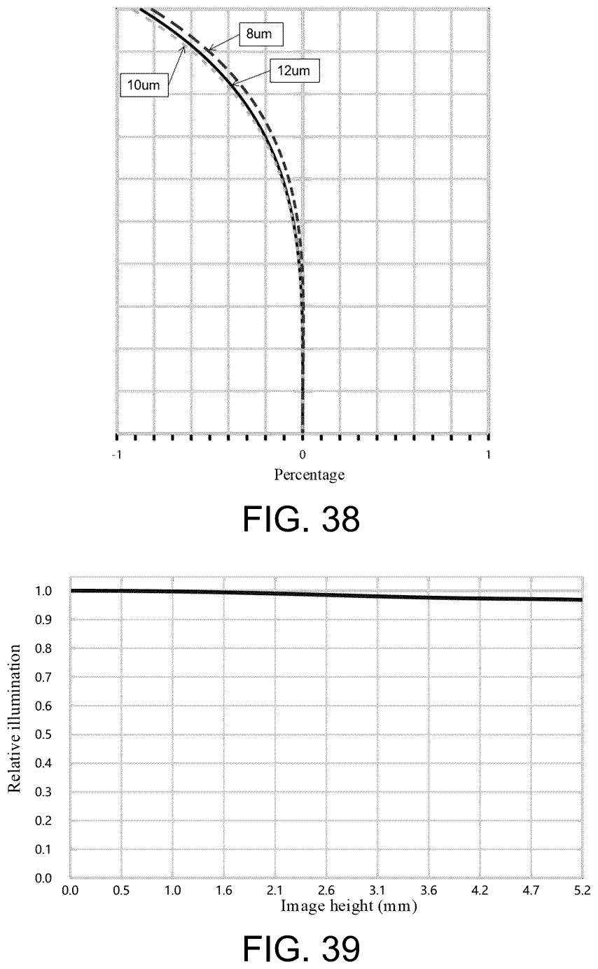

FIG. 38 shows a distortion diagram of the optical system in Embodiment 4 provided by the present application. In the same way, for the meaning of the horizontal and vertical axis of FIG. 8 and the meaning of each curve, the meaning of the horizontal and vertical axis of FIG. 38 and the meaning of each curve will not be repeated here.

It can be seen from FIG. 38 that in the present application the distortions corresponding to each wavelength from 8 μm to 12 μm is less than 1.0%, that is, less than the target requirement of 2%, which indicates that the distortion of the optical system satisfying the target requirement of distortion.

FIG. 39 shows a relative illumination diagram of the optical system in Embodiment 4 provided by the present application. In the same way, for the meaning of the horizontal and vertical axis of FIG. 9 and the meaning of each curve, the meaning of the horizontal and vertical axis of FIG. 39 and the meaning of each curve will not be repeated here.

As shown in FIG. 39, at the central wavelength of 10 μm, the relative illumination at all fields of view of the optical system is greater than 97% all the time, that is, is greater than the target requirement of 95%, which will fully satisfy the target requirement of relative illumination.

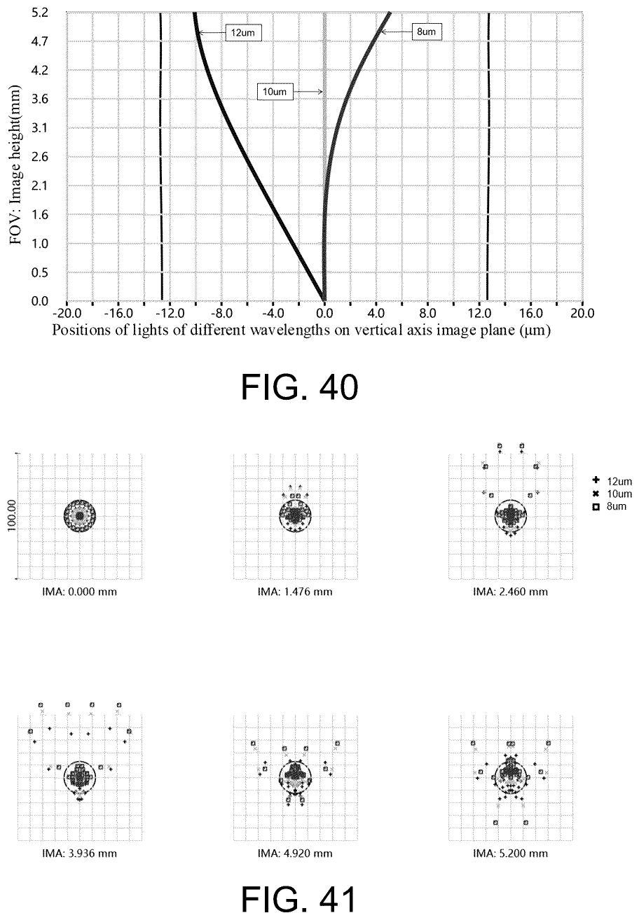

FIG. 40 shows a chromatic aberration diagram of the vertical axis of the optical system in Embodiment 4 provided by the present application. In the same way, for the meaning of the horizontal and vertical axis of FIG. 10 and the meaning of each curve, the meaning of the horizontal and vertical axis of FIG. 40 and the meaning of each curve will not be repeated here.

In FIG. 40, at each wavelength of the waveband of 8-12 μm, the maximum chromatic aberration of vertical axis is about 15.18 μm, which is close to a size of pixel. The maximum chromatic aberrations of vertical axis are all located at the diameter range of the Airy disk, and the optical system still has a lot of margins, indicating the chromatic aberration of the optical system has been compensated well.

FIG. 41 shows a spot diagram of imaging of an optical system provided by Embodiment 4 at room temperature. In FIG. 41, the maximum root mean square radius at the all fields of view is 22.922 μm, which is less than the twice of Airy disk radius of 12.56 μm, thus indicating that the optical system fully meets the requirements for clear imaging.

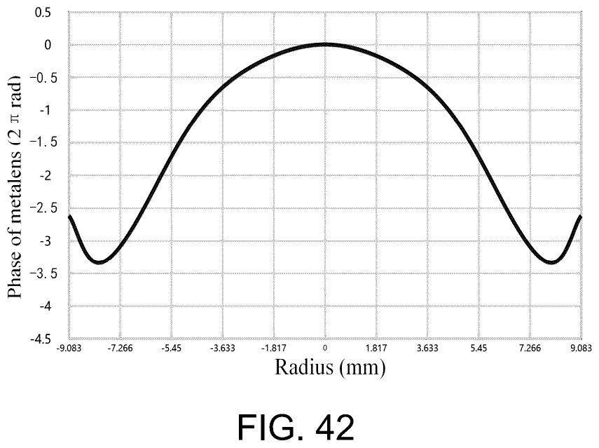

FIG. 42 shows a phase curve of the optical system provided by Embodiment 4. In the same way, for the meaning of the horizontal and vertical axis of FIG. 12 and the meaning of each curve, the meaning of the horizontal and vertical axis of FIG. 42 and the meaning of each curve will not be repeated here.

From FIG. 42 can be seen, the maximum phase difference of the metalens is less than 3.33*2 πrad.

### Embodiment 5

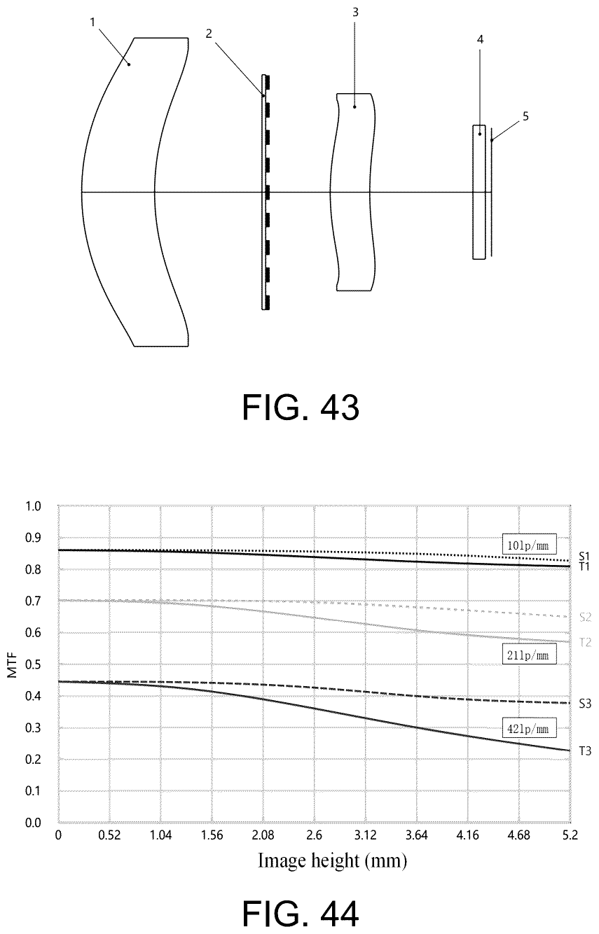

FIG. 43 shows a schematic diagram of the architectural layout of the optical system in embodiment 5 provided by the present application. As shown in FIG. 43, in embodiment 5, the optical system includes three optical elements. Along the optical axis in order from an object plane to an image plane, the three optical elements includes: an aperture slot, a first sulfur refractive lens, a metalens and a second sulfur refractive lens and an optical window glass. And the aperture slot is set on the object-side surface of the first sulfur refractive lens.

Along the direction from the object plane to the image plane, each surface of the optical system is numbered. After summarizing the parameters of each surface, Table 10 is obtained as shown below.

TABLE 10
parameters of each surface from the first sulfur
refractive lens to the image plane

| Surface | | Curvature | | |
|---|---|---|---|---|
| number | Type of surfaces | radius | Thickness | Material |
| 1 | Object plane | Infinite | — | — |
| 2 | Aspherical plane | 18.440 mm | 5.881 mm | Sulfur glass |
| | (Aperture slot) | | | |
| 3 | Aspherical plane | 20.048 mm | 10.223 mm | — |
| 4 | Spherical surface | Infinite | 0.300 mm | Silicon |
| 5 | Spherical surface | Infinite | 4.294 mm | — |
| 6 | Aspherical surface | 19.675 mm | 3.109 mm | Sulfur glass |
| 7 | Aspherical surface | 24.323 mm | 8.485 mm | — |
| 8 | Spherical surface | Infinite | 1.000 mm | Germanium |
| 9 | Spherical surface | Infinite | 0.500 mm | — |
| 10 | Image plane | Infinite | — | — |

In the same way as described for Table 2, Table 10 is not repeated here.

After summarizing the coefficients in the surface formula corresponding to the four surfaces of surface 2, surface 3, surface 6 and surface 7, Table 11 is shown below.

TABLE 11
Coefficients in the surface formula corresponding
to each aspherical surface in Embodiment 5

| | Numbered surface | | | |
|---|---|---|---|---|
| | 2 | 3 | 6 | 7 |
| k | −2.972E+00 | −9.509E−02 | 0 | −1.957E+00 |
| A₄ | 5.196E−05 | −8.203E−06 | −7.757E−05 | −6.508E−05 |
| A₆ | −1.081E−07 | −2.952E−07 | −2.522E−06 | −4.305E−06 |
| A₈ | −4.849E−10 | 1.989E−09 | −1.961E−08 | 1.827E−09 |
| A₁₀ | 4.633E−12 | −3.900E−11 | 3.104E−10 | 2.619E−10 |
| A₁₂ | −3.203E−14 | 1.893E−13 | −6.207E−12 | −1.187E−12 |
| A₁₄ | 2.034E−17 | −2.516E−16 | 0 | 0 |

The optical system provided in this embodiment works in the waveband from 8 to 12 μm; F number of the optical system is 1.02, and F number is within the range of the target requirement of 1.0±5%, which fully meets the requirements of the optical system for the F number.

FIG. 44 shows a curve diagram of the optical system provided by Embodiment 5 at room temperature between the MTF and FOV. In the same way as the description of the meaning of the horizontal and vertical axis in FIG. 5 and the meaning of the curve, the meaning of the horizontal and vertical axis and the meaning of the curve in FIG. 44 will not be repeated here.

From FIG. 44 can be seen, the MTF at 0.8 FOV of the optical systems at the cut-off frequency of 42.00 lp/mm is greater than 0.25 all the time. That is, the MTF is greater than the target requirement of 0.16 all the time. This shows that the imaging quality of the optical system in 0.8 FOV is excellent at room temperature.

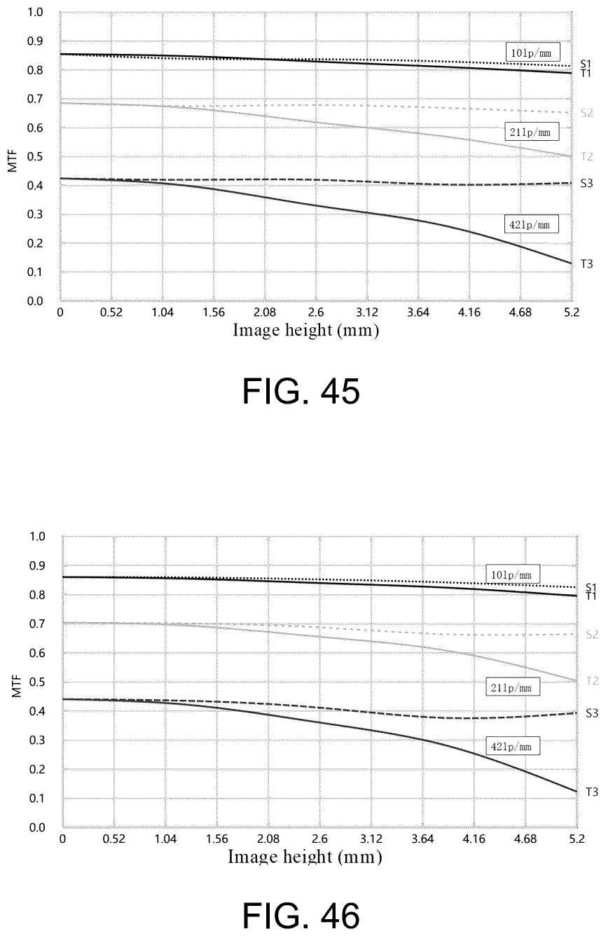

FIG. 45 shows a curve diagram at the temperature of −40° C. between the MTF and field of view of the optical system in Embodiment 5 provided by the present application. Similarly, for the description of the meaning of the horizontal and vertical axis and the meaning of each curve, the meaning of the horizontal and vertical axis of FIG. 45 and the curve will not be repeated here.

As shown in FIG. 45, the MTF of the optical system at 0.8 FOV of the cut-off frequency of 42.00 lp/mm is greater than 0.23, that is, the MTF of the optical system is greater than the target requirement of 0.16, which indicates the optical system at a temperature of −40° C. of 0.8 FOV has good imaging quality.

FIG. 46 shows a curve between the MTF of the optical system at a temperature of 80° C. in Embodiment 5 and the FOV. Similarly, for the meaning of the horizontal and vertical axis of FIG. 4 and the meaning of each curve, the meaning of the horizontal and vertical axis of FIG. 46 and each curve will not be repeated here.

From FIG. 46 can be seen, the optical system provided by the present application, the MTF at a cut-off frequency of 42.00 lp/mm is greater than 0.24 at the temperature of 80° C. at 0.8 FOV, namely the MTF is greater than the target requirement of 0.16 all the time, which indicates that imaging quality of the optical system at the temperature of 80° C. is good.

From FIG. 44 to FIG. 46, the optical system provided by the present application at the temperature from −40° C. to 80° C. keeps good imaging quality all the time, which indicates that the optical system has fully realized the athermalization.

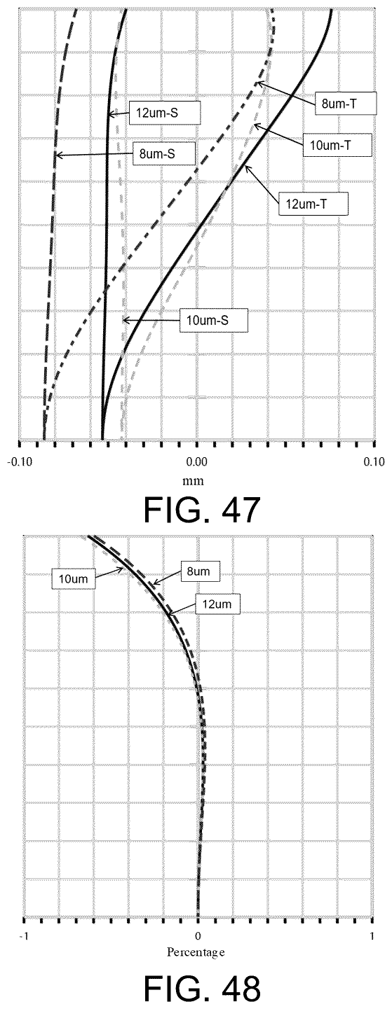

FIG. 47 shows a field curvature diagram of the optical system in Embodiment 5 provided by the present application. In the same way, for the meaning of the horizontal and vertical axis of FIG. 7 and the meaning of each curve, the meaning of the horizontal and vertical axis of FIG. 47 and the meaning of each curve will not be repeated here.

It can be seen from FIG. 47 that the field curvature in the meridional direction is 0.0845 mm at the central wavelength of 10 μm from 8 μm to 12 μm, and the field curvature in the sagittal direction is 0.0043 mm at the central wavelength of 10 μm in the waveband from 8 μm to 12 μm, which indicates that the field curvature of the optical system is small.

FIG. 48 shows a distortion diagram of the optical system in Embodiment 5 provided by the present application. In the same way, for the meaning of the horizontal and vertical axis of FIG. 8 and the meaning of each curve, the meaning of the horizontal and vertical axis of FIG. 48 and the meaning of each curve will not be repeated here.

It can be seen from FIG. 48 that in the present application, the distortions corresponding to each wavelength from 8 μm to 12 μm is less than 0.7%, that is, less than the target requirement of 2%, which indicates that the distortion of the optical system satisfies the target requirement of distortion.

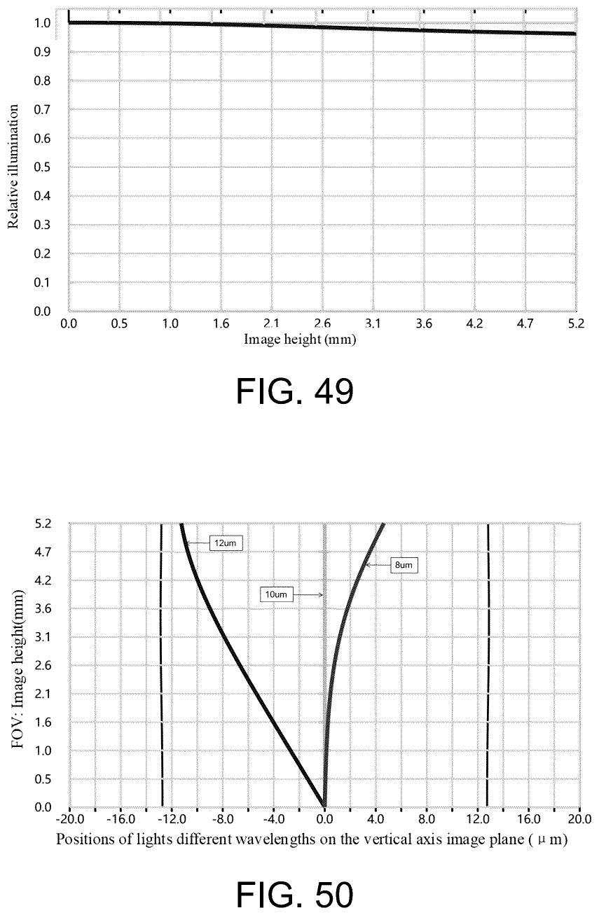

FIG. 49 shows a relative illumination diagram of the optical system in Embodiment 5 provided by the present application. In the same way, for the meaning of the horizontal and vertical axis of FIG. 9 and the meaning of each curve, the meaning of the horizontal and vertical axis of FIG. 49 and the meaning of each curve will not be repeated here.

As shown in FIG. 49, at the central wavelength of 10 μm, the relative illumination at all fields of view of the optical system is greater than the target requirement of 95% all the time, which will fully satisfy the target requirement of relative illumination.

FIG. 50 shows a chromatic aberration diagram of the vertical axis of the optical system in Embodiment 5 provided by the present application. In the same way, for the meaning of the horizontal and vertical axis of FIG. 10 and the meaning of each curve, the meaning of the horizontal and vertical axis of FIG. 50 and the meaning of each curve will not be repeated here.

In FIG. 50, at each wavelength of the waveband of 8-12 μm, the maximum chromatic aberration of vertical axis is about 15.89 μm, which is close to a size of pixel. The maximum chromatic aberrations of vertical axis are all located at the diameter range of the Airy disk, and the optical system still has a lot of margins, indicating the chromatic aberration of the optical system has been compensated well.

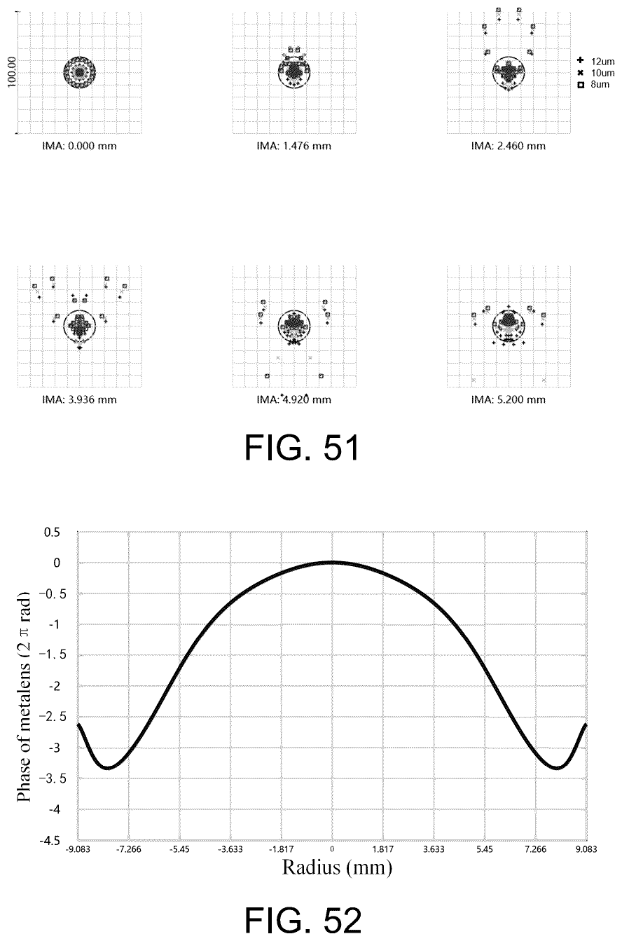

FIG. 51 shows a spot diagram of imaging of an optical system provided by Embodiment 5 at room temperature. In FIG. 51, the maximum root mean square radius at all fields of view is 29.397 μm, which is less than three times of the Airy disk radius of 12.73 μm, thus indicating that the optical system fully meets the requirements for clear imaging.

FIG. 52 shows a phase curve of the optical system provided by Embodiment 4. In the same way, for the meaning of the horizontal and vertical axis of FIG. 12 and the meaning of each curve, the meaning of the horizontal and vertical axis of FIG. 52 and the meaning of each curve will not be repeated here.

From FIG. 52 can be seen, the maximum phase difference of the metalens is less than 2.5*2 μrad.

After summarizing the parameters of the optical system provided by the above five embodiments, Table 12 is shown below. The display in Table 12 is mainly used to explain the conditions met by the optical system provided in this application, are experimentally verified and supported. R₂ is the radius of curvature of the image-side surface of the first sulfur refractive lens, D₂ is the effective radius of the image-side surface of the first sulfur refractive lens, R₆ is the radius of curvature of the image-side surface of the second sulfur refractive lens, and D₆ is the effective radius of the image-side surface of the second sulfur refractive lens.

TABLE 12
The lens parameters of the optical system provided by the present
embodiments

| Condition | Embodiment 1 | Embodiment 2 | Embodiment 3 | Embodiment 4 | Embodiment 5 |
|---|---|---|---|---|---|
| f | 24.92 mm | 24.95 mm | 25.44 mm | 25.51 mm | 25.53 mm |
| f₁ | 38.82 mm | 38.68 mm | 39.26 mm | 38.98 mm | 38.70 mm |
| f_{M} | 459.92 mm | 427.54 mm | 898.21 mm | 824.29 mm | 873.73 mm |
| f₂ | 38.17 mm | 38.47 mm | 37.89 mm | 38.65 mm | 40.55 mm |
| n | 2.77 | 2.77 | 2.77 | 2.77 | 2.77 |
| TTL | 33.16 mm | 33.13 mm | 33.78 mm | 33.81 mm | 33.79 mm |
| BFL | 9.849 mm | 9.848 mm | 9.92 mm | 9.92 mm | 9.98 mm |
| R₁ | 17.898 mm | 17.782 mm | 18.398 mm | 18.495 mm | 18.440 mm |
| R₂ | 19.115 mm | 18.890 mm | 19.841 mm | 20.002 mm | 20.048 mm |
| R₅ | 20.497 mm | 21.202 mm | 18.976 mm | 19.627 mm | 19.675 mm |
| R₆ | 26.504 mm | 27.758 mm | 23.656 mm | 24.679 mm | 24.323 mm |
| D₁ | 12.500 mm | 12.500 mm | 12.500 mm | 12.500 mm | 12.500 mm |
| D₂ | 11.578 mm | 11.491 mm | 11.490 mm | 11.489 mm | 11.533 mm |
| D₅ | 7.545 mm | 7.524 mm | 7.580 mm | 7.566 mm | 7.516 mm |
| D₆ | 7.987 mm | 7.979 mm | 8.043 mm | 8.043 mm | 7.887 mm |
| Δφ | 9.8π rad | 9.7π rad | 6.8π rad | 6.66π rad | 5π rad |
| D_{M} | 9.49 mm | 9.41 mm | 9.08 mm | 9.07 mm | 9.05 mm |
| ca₁ | 8.689 mm | 8.778 mm | 10.276 mm | 10.215 mm | 10.223 mm |
| ct₁ | 5.902 mm | 5.901 mm | 5.916 mm | 5.984 mm | 5.881 mm |
| ca₂ | 5.221 mm | 5.101 mm | 4.271 mm | 4.267 mm | 4.294 mm |
| ct₂ | 3.200 mm | 3.200 mm | 3.098 mm | 3.120 mm | 3.109 mm |
| sag₂₁ | 5.27628E−01 mm | 4.83781E−01 mm | 5.71691E−01 mm | 5.15203E−01 mm | 5.67303E−01 mm |
| sag₂₂ | 7.29645E−02 mm | 3.22257E−02 mm | 9.01253E−02 mm | 4.27563E−02 mm | 1.62422E−01 mm |
| FNO | 1.01 | 1.01 | 1.02 | 1.02 | 1.02 |
| BFL/f | 0.395 | 0.395 | 0.390 | 0.389 | 0.391 |
| BFL/TTL | 0.297 | 0.297 | 0.294 | 0.293 | 0.295 |
| $\frac{f * ( \frac{{R}_{1}}{{D}_{1}} - \frac{{R}_{5}}{{D}_{5}} )}{( TTL - BFL )}$ | −1.373 | −1.495 | −1.100 | −1.190 | −1.225 |
| $\frac{f * ( n - 1 )}{( FNO * {R}_{1} )}$ | 2.440 | 2.459 | 2.400 | 2.393 | 2.402 |
| R₂/R₁ | 1.068 | 1.062 | 1.078 | 1.081 | 1.087 |
| $\frac{{sag}_{21}}{{sag}_{22}}$ | 7.231 | 15.012 | 6.343 | 12.050 | 3.493 |
| f₁/f | 1.558 | 1.550 | 1.543 | 1.528 | 1.516 |
| f₂/f | 1.532 | 1.542 | 1.490 | 1.515 | 1.588 |
| f₁/f₂ | 1.017 | 1.005 | 1.036 | 1.009 | 0.954 |
| f_{M}/f | 18.456 | 17.136 | 35.307 | 32.312 | 34.224 |
| $\frac{2 {f}_{M}}{( {f}_{1} + {f}_{2} )}$ | 14.580 | 13.483 | 28.366 | 25.695 | 26.445 |
| Δφ/D_{M} | 3.244 rad/mm | 3.238 rad/mm | 2.353 rad/mm | 2.307 rad/mm | 1.736 rad/mm |
| $\vert \frac{{ca}_{1} {ct}_{2}}{{ct}_{1} - {ca}_{2}} \vert$ | 0.159 | 0.107 | 0.358 | 0.339 | 0.357 |

The above is only a specific embodiment of the embodiments of this disclosure, but the scope of protection of the embodiment of this disclosure is not limited to this. And those skilled in the field can easily think of any change or substitution for this disclosure, which should be covered within the protection scope of this disclosure. Therefore, the scope of the protection of the present disclosure shall be the scope of the claims.

What is claimed is:

1. An optical system, the optical system comprising three optical elements, wherein along the optical axis in order from an object plane to an image plane, the three optical elements comprise: a first sulfur refractive lens, a metalens and a second sulfur refractive lens;
each of three optical elements comprises an object-side surface facing towards the object plane and an image-side surface facing towards the image plane;
the first sulfur refractive lens and the second sulfur refractive lens are even aspheric optical lenses;
the object-side surface of the first sulfur refractive lens is a convex surface;
each of the object-side surface of the second sulfur refractive lens and the image-side surface of the second sulfur refractive lens comprises one inflection point;
the first sulfur refractive lens, the metalens and the second sulfur refractive lens have positive focal power.

2. The optical system according to claim 1, wherein the optical system satisfies the following condition:
$$0.95 < f / epd < 1 \text{.05} .$$
wherein f is an effective focal length of the optical system, and epd is a pupils diameter of the optical system.

3. The optical system according to claim 1, wherein the optical system satisfies the following condition:
$$0.38 < BFL / f < 0.4$$
$$0.29 < BFL / TTL < 0.3$$
wherein BFL is a back focal length of the optical system; f is an effective focal length of the optical system; TTL is a total track length of the optical system.

4. The optical system according to claim 1, wherein the optical system satisfies the following condition:
$$- 1 \text{.5} < f * ( \frac{{R}_{1}}{{D}_{1}} - \frac{{R}_{5}}{{D}_{5}} ) / ( TTL - BFL ) < - 1$$
wherein f is an effective focal length of the optical system, R₁ is a curvature radius of the object-side surface of the first sulfur refractive lens, D₁ is an effective radius of object-side surface of the first sulfur refractive lens, R₅ is a curvature radius of the object-side surface of the second sulfur refractive lens, D₅ is an effective radius of the object-side surface of the second sulfur refractive lens, TTL is a total track length of the optical system, BFL is a back focal length of the optical system.

5. The optical system according to claim 1, wherein the optical system satisfies the following condition:
$$2.3 < f * ( n - 1 ) / ( FNO * {R}_{1} ) < 2.5$$
wherein f is an effective focal length of the optical system; n is a refractive index of the first sulfur refractive lens, FNO is a F number of the optical system; R₁ is a curvature radius of the object-side surface of the first sulfur refractive lens.

6. The optical system according to claim 1, wherein the optical system satisfies the following condition:
$$1.06 < {R}_{2} / {R}_{1} < 1.09$$
wherein R₁ is a curvature radius of the object-side surface of the first sulfur refractive lens; R₂ is a curvature radius of the image-side surface of the first sulfur refractive lens.

7. The optical system according to claim 1, wherein the optical system satisfies the following condition:
$$3.4 < {sag}_{21} / {sag}_{22} < 15.1$$
wherein sag₂₁ is a sagittal height at a maximum radius of the object-side surface of the second sulfur refractive lens, sag₂₂ is a sagittal height at a maximum radius of the image-side surface of the second sulfur refractive lens.

8. The optical system according to claim 1, wherein the optical system satisfies the following condition:
$$1.5 < {f}_{1} / f < 1.6$$
$$1.48 < {f}_{2} / f < 1.6$$
$$0.9 < {f}_{1} / {f}_{2} < 1.05$$
wherein f₁ is a focal length of the first sulfur refractive lens, f₂ is a focal length of the second refractive lens, f is an effective focal length of the optical system.

9. The optical system according to claim 1, wherein the optical system satisfies the following condition:
$$17 < {f}_{M} / f < 35.5$$
$$13 < 2 {f}_{M} / ( {f}_{1} + {f}_{2} ) < 29$$
wherein f_{M} is a focal length of the metalens; f is an effective focal length of the optical system; f₁ is a focal length of the first sulfur refractive lens; f₂ is a focal length of the second sulfur refractive lens.

10. The optical system according to claim 1, wherein the optical system satisfies the following condition:
$$1.7 rad / mm < Δ φ / {D}_{M} < 3.3 rad / mm$$
wherein Δϕ is a maximum phase difference of the metalens, D_{M} is an effective optical radius of the metalens.

11. The optical system according to claim 1, wherein the optical system satisfies the following condition:
$$0.1 < \vert {ca}_{1} / {ct}_{1} - {ca}_{2} / {ct}_{2} \vert < 0. 4$$
wherein ca₁ is a paraxial distance between the central image-side surface of the first sulfur refractive lens and the metalens; ct₁ is a central thickness of the first sulfur refractive lens; ca₂ is a paraxial distance between the metalens and the central object-side surface of the second sulfur refractive lens; ct₂ is a central thickness of the second sulfur refractive lens.

12. The optical system according to claim 1, wherein the optical system further comprises: an aperture slot; the aperture slot is next to the object-side surface of the first sulfur refractive lens; the aperture slot is set on a surface of the metalens.

13. The optical system according to claim 1, wherein the optical system further comprises: an aperture slot; an air gap is set between the aperture slot and the metalens; the aperture slot is next to the object-side surface of the first sulfur refractive lens.

14. The optical system according to claim 1, wherein a total track length of the optical system is less than 34 mm.

15. The optical system according to claim 1, wherein a back focal length of the optical system is less than 9.99 mm.

16. The optical system according to claim 1, wherein a maximum phase difference of the optical system is greater than 5 πt rad and is less than 9.8 π rad.

17. The optical system according to claim 1, wherein an effective focal length of the optical system is less than or equal to 25.51 mm; a focal length of the first sulfur refractive lens is less than or equal to 39.26 mm; a focal length of the second sulfur refractive lens is less than or equal to 40.55 mm; a focal length of the metalens is less than or equal to 898.21 mm.

18. The optical system according to claim 1, wherein the optical system comprises an optical window glass;
and the optical window glass is set between the second sulfur refractive lens and the image plane.

19. An optical camera, wherein the optical camera comprises a lens barrel, and the optical system claimed as claim 1;
the lens barrel comprises three platforms, the three platforms are successively along the optical axis in order from an object plane to an image plane: a first platform, a second platform, and a third platform; the first sulfur refractive lens is set on the first platform, the metalens is set on the second platform, and the second sulfur refractive lens is set on the third platform.

20. The optical camera according to claim 19, wherein a first pressuring ring contacts the object-side surface of the first sulfur refractive lens; a disconnected ring contacts the image-side surface of the first sulfur refractive lens; and the disconnected ring contacts the object-side surface of the metalens; and a second pressuring ring contacts the image-side surface of the second sulfur refractive lens.
